(19) United States
(12) Patent Application Publication
(10) Pub. No.: US 2006/0048963 A1
(43) Pub. Date: Mar. 9, 2006

(54) Laminate, printed circuit board, and preparing method thereof

(76) Inventors: Masaru Nishinaka, Shiga (JP); Takashi Itoh, Shiga (JP); Shigeru Tanaka, Osaka (JP); Mutsuaki Murakami, Osaka (JP)

Correspondence Address: HOGAN & HARTSON L.L.P., 500 S. GRAND AVENUE, SUITE 1900, LOS ANGELES, CA, 90071-2611, US

(21) Appl. No.: 10/537,838

(22) PCT Filed: Dec. 5, 2003
(86) PCT No.: PCT/JP03/15577

§ 371 Date: Jun. 6, 2005

(30) Foreign Application Priority Data
Dec. 5, 2002 (JP) 2002354424
Jan. 31, 2003 (JP) 200323399
Mar. 14, 2003 (JP) 200371059
Mar. 14, 2003 (JP) 200371060
Mar. 20, 2003 (JP) 200377312

(51) Int. Cl. B32B 15/08

(52) U.S. Cl. 174/52.2; 428/458; 428/626

(57) ABSTRACT

A laminate which comprises a thermoplastic polyimide layer and a metal layer, or comprises a non-thermoplastic polyimide film layer and, formed on one or both surfaces, a thermoplastic polyimide layer and a metal layer; and a printed wiring board comprising the laminate. The laminate can be used for forming a high density circuit thereon, exhibits good resistance to further processing such as desmearing and excellent adhesion, and is excellent in adhesion reliability in a high temperature atmosphere.

### TECHNICAL FIELD

The present invention relates to a laminate forming a copper metal layer on a polymeric film which has a smooth plane, the laminate being widely used for an electric or electrical device and a method for preparing a printed circuit board using the laminate.

In particular, the present invention relates to a two-layer structured laminate which comprises a metal film layer/a polyimide film layer optimal to prepare of a printed circuit board or a three-layer structured laminate which comprises a metal layer/a polyimide film/a metal layer; a metal layer/a polyimide film layer/a copper foil layer; or a metal layer/a polyimide film layer/an adhesive layer.

More particular, the present invention relates to a printed circuit board and a preparing method of the printed circuit board, to which a treatment for preparing a general printed circuit board can be applied such as a via hole forming step and a step of de-smearing, which is excellent in adhesion property and environmental stability, and which can be used for: a high-density flexible printed circuit board; a multi-layered flexible printed circuit board laminated with flexible printed circuit board; a rigid flex circuit board laminated with a flexible circuit board and a hard printed circuit board; a buildup circuit board; a TAB (Tape Automated Bonding) tape; a COF (Chip On Film) having a semiconductor element directly mounted on a printed circuit board; and an MCM (Multi Chip Module) substrate or the like.

### BACKGROUND ART

A printed circuit board having a circuit formed on a surface is widely used for packaging electronic parts or semiconductor elements and the like. In recent years, with a growing demand for downsizing and high performance of an electronic device, a high density and thin type circuit has been strongly desired for such a printed circuit board. In particular, it is an important issue in the field of printed circuit board to establish a method for forming a very small circuit having a line/space gap of 25 μm/25 μm or less.

In general, in a printed circuit board, adhesion between a polymeric film serving as a substrate and a circuit is charged by irregularities of a surface called an anchor effect. Thus, the step of roughening a film surface is typically provided. In general, on that surface, irregularities having about 3 μm to 5 μm are provided in accordance with R_{Z} value conversion. Although such irregularities of the substrate surface are not problematic in the case where a value of a line/space of a circuit to be formed is 30 μm/30 μm or more, they become a serious problem in forming a circuit having a line width of 30 μm/30 μm or less, in particular, of 25 μm/25 μm or less. The reason is that a circuit line which is such a high density thin line is affected by the irregularities of the substrate surface. Therefore, a technique of forming a circuit on a polymeric substrate having high surface smoothness is required to form a circuit having a line/space value of 25 μm/25 μm or less. Its flatness is 2 μm or less in R_{Z} value conversion, further desirably, 1 μm or less. Of course, in this case, the anchor effect cannot be expected as an adhesion force, and thus, development of another adhesion method is required.

On the other hand, higher density fine wiring is required for a printed circuit board, and at the same time, stability under a severer environment such as high temperature or high humidity becomes required. In particular, with respect to adhesion property between a polymeric film and a wiring circuit as well, there is a demand for such bonding to be durable under a high temperature and/or high humidity environment.

Further, it is indispensable to form a via hole for making an inter-layered circuit conductive for a double-sided printed circuit board or a multi-layered printed circuit board. Thus, on the printed circuit board, in general, a circuit is formed through a step of forming via hole using a laser, a step of de-smearing, a step of applying a catalyst, and a step of conducting an electroless plating of copper. Here, there is widely used a method using agents having a large environmental load such as permanganate on the step of de-smearing, and formaldehyde or EDTA on the electroless plating step. However, in recent years, with a growing demand for environment protection, a treatment which does not use these agents is required.

As a treatment which achieves this demand, there is discussed a method for preparing a printed circuit board by using a physical vapor deposition technique such as sputtering. In this technique, there is disclosed a method for forming an insulating layer and a via hole consisting of a polyimide resin on a circuit, followed by fully carrying out sputtering and making conductive the insulating layer and via hole consisting of the polyimide resin. However, the polyimide resin used here is non-thermoplastic polyimide, and sufficient adhesion property cannot be expected (JP-A-5-251626).

Further, there is a case where a circuit is formed in accordance with a so called subtractive process (JP-A-2000-198907) or preparedin accordance with a so called semi-additive process which consists of: a step of forming a resist film; a step of carrying out electroplating of copper for a portion at which an electrolessly plated film is exposed; a step of removing a resist film; and a step of etching of a redundant electrolesslyplated film of copper. Therefore, the adhesion property between a wiring circuit and a polymeric film is, of course, required to be durable in these treatments.

Up to now, a variety of studies have been attempted with respect to improvement of the adhesion property between a polyimide film and a wiring circuit. For example, there are disclosed, for example, a technique of improving adhesion property (Japanese Patent No. 1,948,445 (U.S. Pat. No. 4,742,099), or alternatively, polyimide or the like coated with a metal salt which consists of Sn, Cu, Zn, Fe, Co, Mn, or Pd and improved in surface adhesion force (JP-A-6-73209 (U.S. Pat. No. 5,227,224)). In addition, there is disclosed a method for metalizing a polyimide film imidized after applying a heat-resistant surface treating agent to a polyamic acid solidified film (U.S. Pat. No. 5,130,192). Further, there is disclosed a technique of providing a titanium element on a surface of a polyimide film (JP-A-11-71474). In addition, by the Inventor et al, there is disclosed a technique of forming a conductor layer on a thermoplastic polyimide surface in accordance with a dry plating technique, pressurizing, heat-treating, and fusing it, and then, strengthening adhesion strength between polyimide and an adhesive layer (JP-A-2002-113812).

In addition, there is disclosed a method for bonding a metal foil and thermoplastic polyimide as a challenge for improvement of adhesion property of the metal foil (JP-A-8-230103).

A metal layer formed on each of these polyimide film surface in accordance with a physical technique such as vapor deposition has excellent adhesion strength as compared with a metal layer formed on a general polyimide surface. However, there is a case in which adhesion between a polyimide film and a metal fabricated in accordance with these inventive methods is released in accordance with the step of forming a via hole using a laser and the step of de-smearing.

In addition, there is disclosed a method for carrying out electroless plating treatment after a hydrophilization treatment of a polyimide film has been carried out (JP-A-5-90737). Further, there is disclosed a method for conducting electroless plating to the thus hydrophilized polyimide film, followed by applying heat treatment under an inert atmosphere (JP-A-8-31881). However, these methods presume treatment of a non-thermoplastic polyimide resin. Thus, as is the case with the foregoing description, the durability in the step of de-smearing is low.

### DISCLOSURE OF INVENTION

The present invention has been made in order to solve the foregoing problem. It is an object of the present invention to:
(1) form a very small wiring circuit rigidly bonded on a polyimide film having excellent surface smoothness; (2) achieve adhesion property durable in a treatment for preparing a printed circuit board from the step of forming a via hole by using a laser and the step of de-smearing to a final step; and (3) provide a printed circuit board having excellent adhesion stability under a normal condition and under a high temperature and/or a high humidity environment.

Furthermore, it is another object of the present invention to (4) eliminate use of wet type electroless plating having a large environmental load considering an environment.

The Inventor et al made utmost effort for research and development in order to the above described problem. As a result, the of a metal layer/polyimide film layer and three-layer structured laminate which consists of: a metal layer/a polyimide film layer/a metal layer; a metal layer/a polyimide film layer/copper foil layer; or a metal layer/a polyimide film layer/an adhesive layer, the laminated elements each meeting the above described conditions, and achieved the present invention.

In addition, the Inventor et al found out that surface treatment carried out by combining at least one or more treatments selected from among an ion gun treatment, a plasma treatment, a corona treatment, a coupling agent treatment, a permanganate treatment, a ultraviolet ray emitting treatment, an electron beam emitting treatment, surface treatment by colliding an abrasive at a high speed, a firing treatment, and a hydrophilization treatment is effective for the improvement of an adhesion force of a metal layer.

Furthermore, the Inventor et al found out that it is effective to use a very simple method for, when a metal element is deposited onto a thermoplastic polyimide layer to form a metal layer, heating a thermoplastic polyimide resin.

That is, the present invention relates to a laminate which comprises a thermoplastic polyimide layer and a metal layer on a surface of the thermoplastic polyimide layer.

It is preferable that the thermoplastic polyimide layer is surface-treated by at least one treatment selected from the group consisting of a plasma treatment, a corona treatment, a coupling agent treatment, a permanganate treatment, a ultraviolet ray emitting treatment, an electron beam emitting treatment, surface treatment by colliding an abrasive at a high speed, a firing treatment, and a hydrophilization treatment.

It is preferable that the thermoplastic polyimide layer is surface-treated by means of an ion gun treatment.

It is preferable that the ion gun treatment is a treatment using an argon ion.

It is preferable that the metal layer is formed by depositing a metal element while heating the thermoplastic polyimide layer.

It is preferable that a heating temperature of the thermoplastic polyimide layer is at least 100° C.

It is preferable that the metal layer is an electrolessly plated layer.

It is preferable that the metal layer is formed by at least one method selected from the group consisting of a sputtering method, a vacuum vapor deposition method, an ion plating method, an electron beam vapor deposition method, and a chemical vapor deposition method.

It is preferable that the metal layer comprises a first metal layer and a second metal layer.

It is preferable that the first metal layer comprises nickel, cobalt, chrome, titanium, molybdenum, tungsten, zinc, tin, indium, gold, or an alloy thereof.

It is preferable that the second metal layer comprises copper or an alloy thereof.

The present invention relates to a laminate which comprises a non-thermoplastic polyimide layer having a thermoplastic polyimide layer on at least one face and a metal layer formed at least one face of the thermoplastic polyimide layer surfaces.

The present invention relates to a laminate which comprises a thermoplastic polyimide layer and a metal layer formed on the thermoplastic polyimide layer on one surface, and an adhesive layer on the other face.

The present invention relates to a laminate which comprises a thermoplastic polyimide layer and a metal layer formed on the thermoplastic polyimide layer on one surface, and a copper foil on the other face.

It is preferable that the thermoplastic polyimide layer is surface-treated by at least one treatment selected from the group consisting of a plasma treatment, a corona treatment, a coupling agent treatment, a permanganate treatment, a ultraviolet ray emitting treatment, an electron beam emitting treatment, surface treament by colliding an abrasive at a high speed, a firing treatment, and a hydrophilization treatment.

It is preferable that the thermoplastic polyimide layer is surface-treated by an ion gun treatment.

It is preferable that the ion gun treatment is a treatment using an argon ion.

It is preferable that the metal layer is formed by depositing a metal element while heating the thermoplastic polyimide layer.

It is preferable that a heating temperature of the thermoplastic polyimide layer is at least 100° C.

In addition, the present invention relates to a laminate which comprising a polyimide film and a metal layer, wherein the polyimide film is at least two-layered structure which comprises a non-thermoplastic polyimide layer and a thermoplastic polyimide layer formed on at least one face of the non-thermoplastic polyimide layer; and the metal layer comprises a first metal layer which comprises nickel, cobalt, chrome, titanium, molybdenum, tungsten, zinc, tin, indium, gold, or an alloy thereof, and a second metal layer which comprises copper or an alloy thereof on the first metal layer.

It is preferable that the thermoplastic polyimide layer comprises a thermoplastic polyimide which is obtained by dehydration and ring-closing a polyamic acid represented by the following general formula (1). 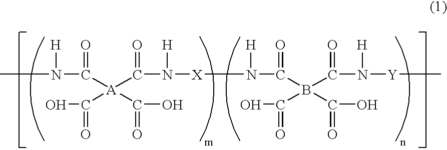
(wherein A is a quadrivalent organic group selected from the following formula (2), and may be the same or different; X is a divalent organic group selected from the following formula (3), and may be the same or different; B is a quadrivalent organic group other than those represented by formula (2), and may be the same or different; Y is a divalent organic group other than those represented by formula (3), and may be the same or different. m:n is 100:0 to 50:50.)

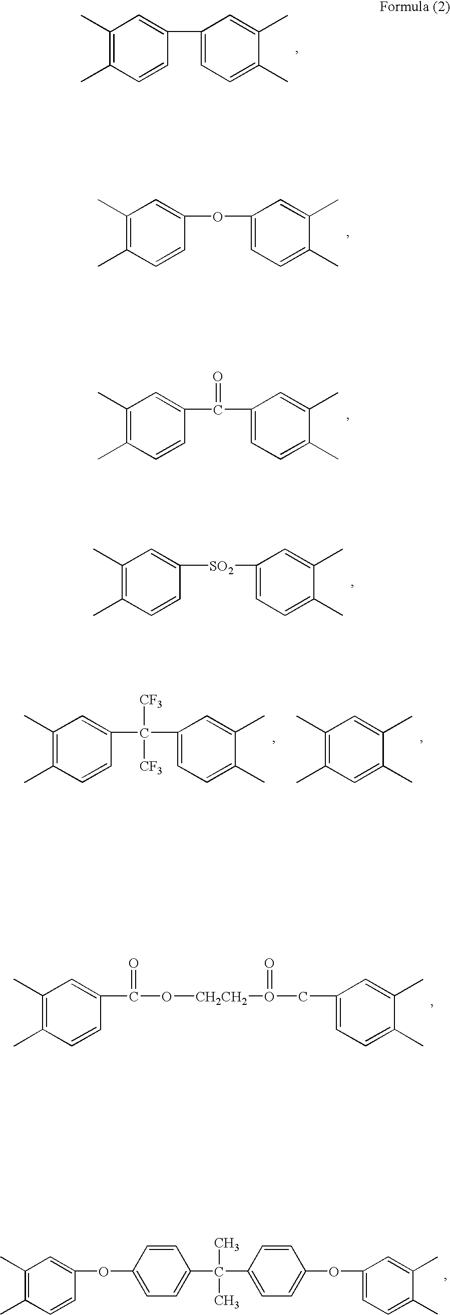

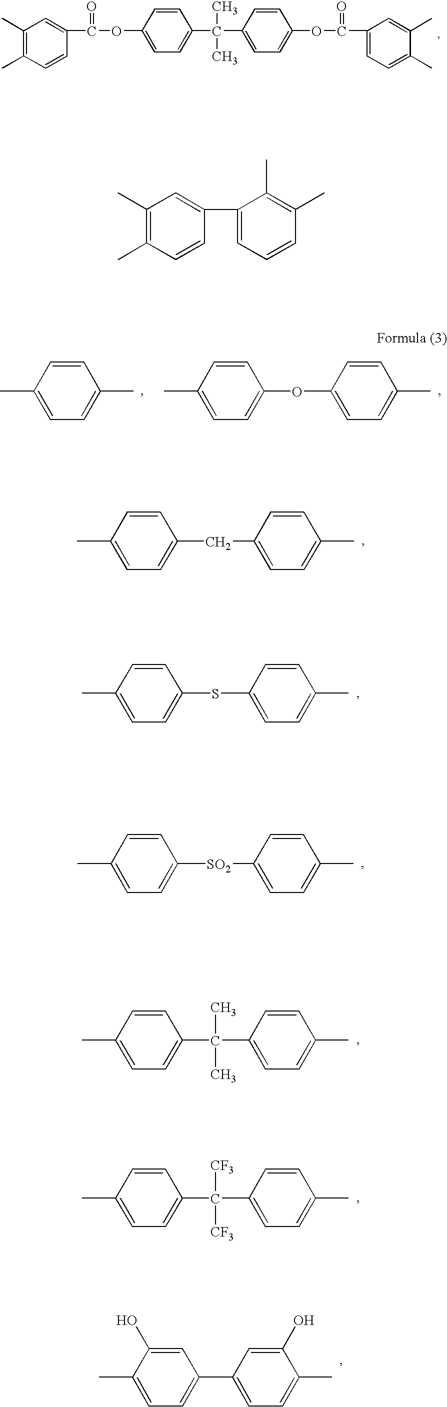

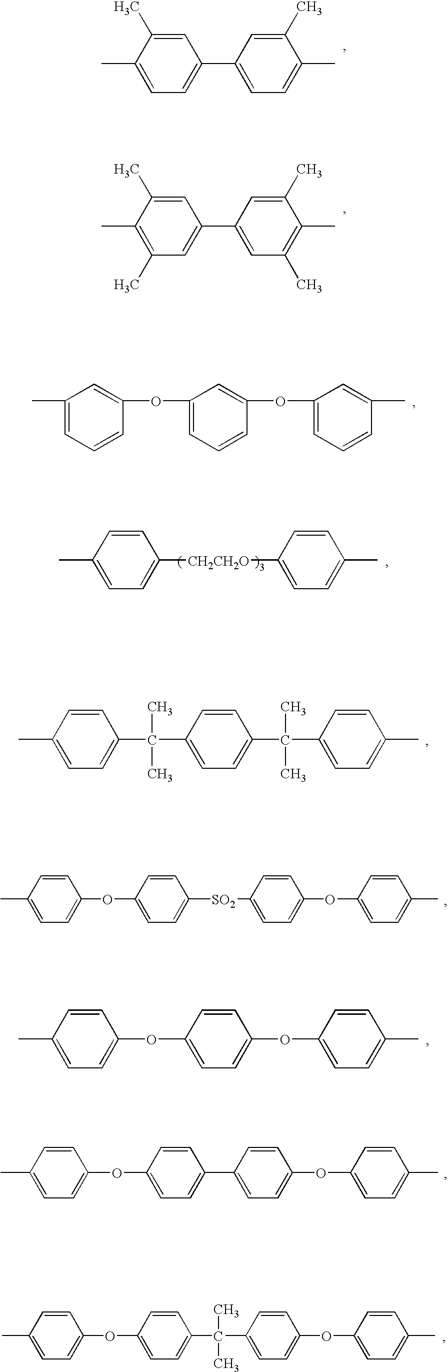

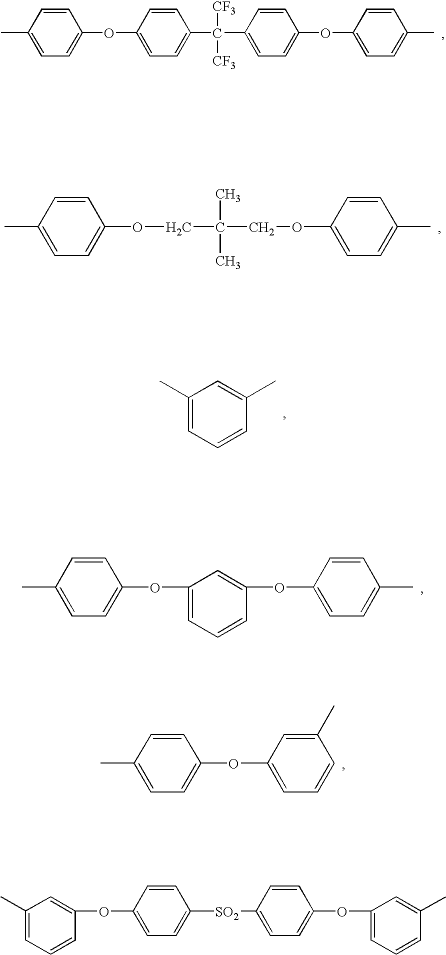

It is preferable that the thickness of the thermoplastic polyimide layer is at least 0.01 μm to at most 10 μm, and is thicker than the non-thermoplastic polyimide layer.

The present invention relates to a thermoplastic polyimide film which is obtained by surface-treated by at least one treatment selected from the group consisting of a plasma treatment, a corona treatment, a coupling agent treatment, a permanganate treatment, a ultraviolet ray emitting treatment, an electron beam emitting treatment, surface treatment by colliding an abrasive at a high speed, a firing treatment, and a hydrophilization treatment.

In addition, the present invention relates to a method for preparing a printed circuit board, which comprises the steps of: forming a thermoplastic polyimide resin layer on one face of a non-thermoplastic polyimide film; forming an adhesive layer on the other face of the non-thermoplastic polyimide film; opposing the adhesive layer and a circuit face of a circuit-formed circuit board to each other to laminate in accordance with a method using heating and/or pressurization; and carrying out panel plating in accordance with a physical vapor deposition method on a surface of the thermoplastic polyimide layer after laminating.

Further, the present invention relates to a method for preparing a printed circuit board, which comprises the steps of: forming a thermoplastic polyimide resin layer on one face of a non-thermoplastic polyimide film; laminating the other face of the non-thermoplastic polyimide film on a circuit formed circuit board via an adhesive sheet in according with a method using heating and/or pressurizing; and carrying out panel plating in accordance with a physical vapor deposition method on a surface of the thermoplastic polyimide layer after laminating.

### BRIEF DESCRIPTION OF DRAWINGS

FIG. 1 is a view showing an example of a construction of the present invention.

FIG. 2 is a view showing an example of a construction of the present invention.

FIG. 3 is a view showing an example of a construction of the present invention.

FIG. 4 is a view showing an example of a construction of the present invention.

### BEST MODE FOR CARRYING OUT THE INVENTION

A laminate according to the present invention consists of a thermoplastic polyimide layer and a metal layer or a non-thermoplastic polyimide film layer, and a thermoplastic polyimide layer and a metal layer formed on one face or both face thereof.

The thermoplastic polyimide for use in the present invention will be described here. It is preferable that the thermoplastic polyimide be obtained by dehydrating and ring-closing a polyamic acid expressed by general formula (1) below: 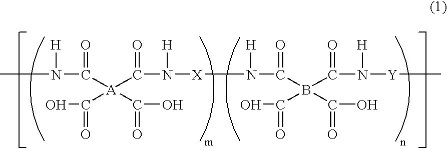
(wherein A is a quadrivalent organic group selected from formula (2) below, which may be identical or different; X is a divalent organic group selected from the formula (3), which may be identical or different; B is a quadrivalent organic group other than those represented in formula (2) below, which may be identical or different; Y is a divalent organic group other than those represented in formula (3) below, which may be identical to different), 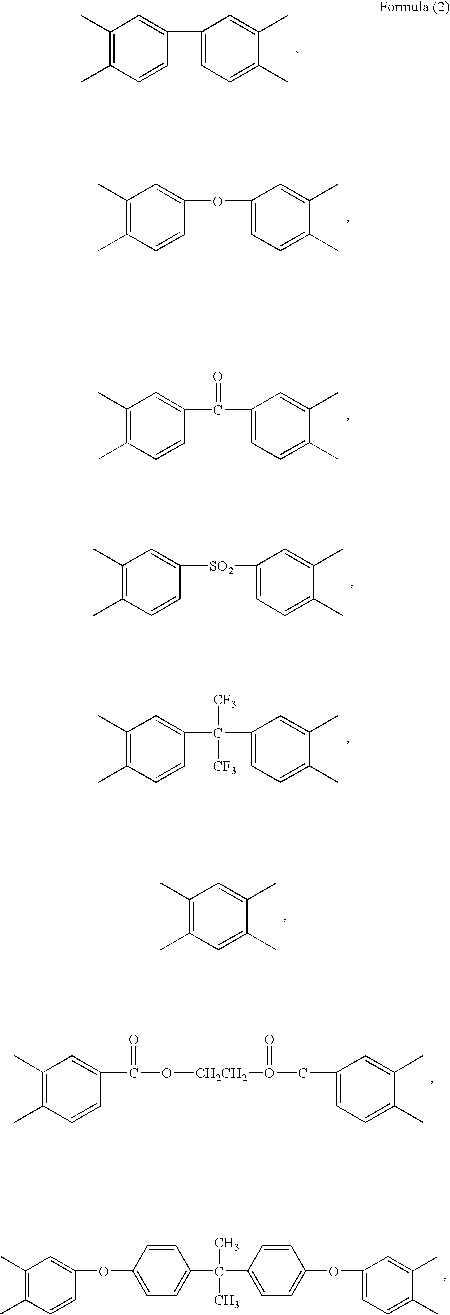 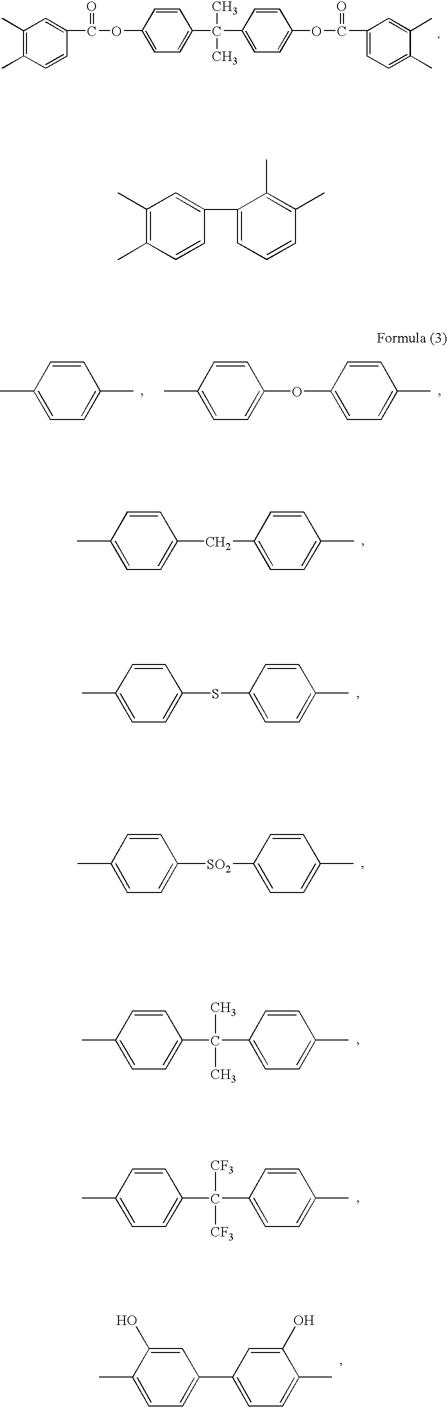 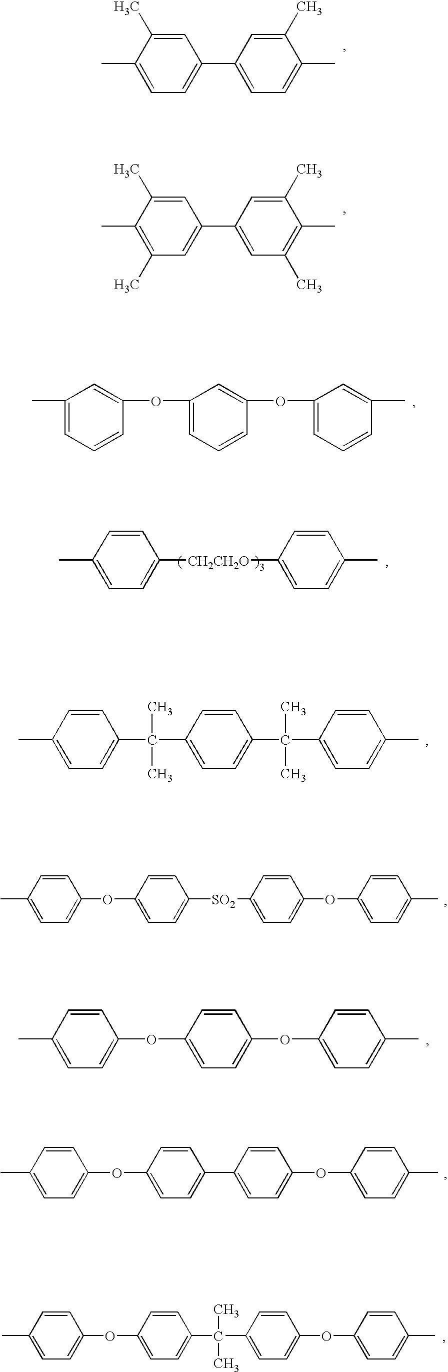 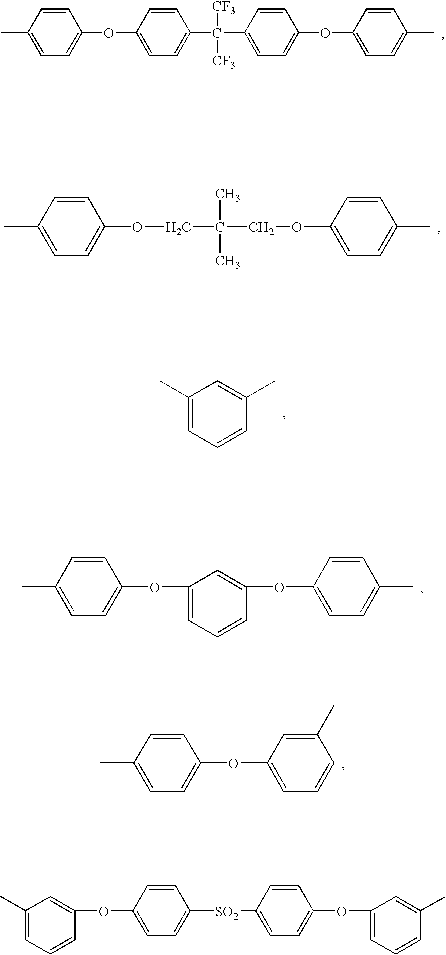
wherein m:n is 100:0 to 50:50, preferably 100:0 to 70:30, and more preferably, 100:0 to 90:10.

In order to obtain the thermoplastic polyimide for use in the present invention, it is possible to use acid dianhydride which impart a residue of acid dianhydride represented in formula (2) above and other acid dianhydride component having quadrivalent organic groups represented by B in general formula (1). Such acid dianhydride can include an aromatic tetracarboxylic acid dianhydride, for example, 2,2′,3,3′-biphenyltetracarboxylic acid dianhydride; bis(2,3-dicarboxyphenyl)methane dianhydride; bis(3,4-dicarboxyphenyl)methane dianhydride; 1,1-bis(2,3-dicarboxyphenyl)ethane dianhydride, 1,1-bis(3,4-dicarboxyphenyl)ethane dianhydride; 1,2-bis(3,4-dicarboxyphenyl)ethane dianhydride; 2,2-bis(3,4-dicarboxyphenyl)propane dianhydride; 1,3-bis(3,4-dicarboxyphenyl)propane dianhydride; 1,2,5,6-naphthalentetracarboxylic acid dianhydride; 2,3,6,7-naphthalenetetracarboxylic acid dianhydride; 3,4,9,10-perylenetetracarboxylic acid dianhydride, p-phenylenebis(trimellitic acid monoester anhydride); or p-phenylenediphthalic acid anhydride.

In addition, in order to obtain these thermoplastic polyimide, it is possible to use diamine which imparts a diamine residue represented in formula (3) above and other diamine component having a divalent organic group represented by Y in general formula (1). Such diamine includes: for example, 1,2-diaminobenzene, benzidine, 3,3′-dichrolobenzidine; 3,3′-dimethoxybenzidine; 1,5-diaminonaphthalene; 4,4′-diaminodiphenyldiethyl silane; 4,4′-diaminodiphenyl silane; 4,4′-diaminodiphenylethylphosphine Oxide; 4,4′-diaminodiphenylN-methylamine; 4,4′-diaminodiphenylN-phenylamine, 3,3′-diaminodiphenyl ether; 4,4′-diaminodiphenyl thioether; 3,4′-diaminodiphenyl thioether; 3,3′-diaminodiphenyl thioether; 3,3′-diaminodiphenylmethane; 3,4′-diaminodiphenylmethane; 3,4′-diaminodiphenyl sulfone; 3,3′-diaminodiphenyl sulfone; 4,4′-diaminobenzanilide; 3,4′-diaminobenzanilide; 3,3′-diaminobenzanilide; 4,4′-diaminobenzophenon; 3,4′-diaminobenzophenon; 3,3′-diaminobenzophenon; bis[4-(3-aminophenoxy)phenyl]methane; bis[4-(4-aminophenoxy)phenyl]methane; 1,1-bis[4-(3-aminophenoxy)phenyl]ethane; 1,1-bis(4-(4-aminophenoxyphenyl)methane; 1,2-bis[4-(3-aminophenoxy)phenyl]ethane; 1,2-bis[4-(4-aminophenoxy)phenyl]ethane; 2,2-bis[4-(3-aminophenoxy)phenyl]propane; 2,2-bis[4-(3-aminophenoxy)phenyl]butane; 2,2-bis[3-(3-aminophenoxy)phenyl]-1,1,1,3,3,3-hexafluoropropane; 1,4-bis(3-aminophenoxy)benzene; 4,4′-bis(3-aminophenoxy)biphenyl; bis[4-(3-aminophenoxy)phenyl]ketone; bis[4-(4-aminophenoxy)phenyl]ketone; bis[4-(3-aminophenoxy)phenyl] sulfide; bis[4-(4-aminophenoxy)phenyl]sulfide; bis[4-(3-aminophenoxy)phenyl]ether; bis[4-(4-aminophenoxy)phenyl]ether; 1,4-bis[4-(3-aminophenoxy)benzoyl]benzene; 1,3-bis [4-(3-aminophenoxy)benzoyl]benzene; 4,4′-bis[3-(4-aminophenoxy)benzoyl]diphenyl ether; 4,4′-bis[3-(3-aminophenoxy)benzoyl]diphenyl ether; 4,4′-bis[4-(4-amino-α,α-dimethylbenzyl)phenoxy]benzophenone; 4,4′-bis[4-(4-amino-α,α-dimethylbenzyl)phenoxy]diphenyl sulfone; bis[4-{4-(4-aminophenoxy)phenoxy}phenyl]sulfone; 1,4-bis[4-(4-aminophenoxy)-α,α-dimethylbenzyl]benzene; 1,3-bis[4-(4-aminophenoxy)-α,α-dimethylbenzyl]benzene; 4,4′-diaminodiphenylethyl phosphine oxide and analogous thereof.

As a combination between the acid dianhydride and diamine for obtaining a thermoplastic polyimide for use in the present invention, it is preferable to use a combination of at least one kind of acid dianhydride selected from acid dianhydrides which impart acid dianhydride residues represented in formula (2) and at least one kind of diamine selected from diamines which impart diamine residues represented in formula (3). Among them, as acid dianhydrides, there can be industrially obtained: 2,3,3′,4′-biphenyltetracarboxylic acid dianhydride; 3,3′,4,4′-biphenyltetracarboxylic acid dianhydride; oxydiphtalic acid anhydride; ethylene bis(trimellitic acid monoester acid anhydride); bisphenol A bis(trimellitic acid monoester acid anhydride); p-phenylene bis(trimettitic acid monoester acid anhydride); or 4,4′-(4,4′-isopropylidenediphenoxy)bis(anhydrous phthalic acid). As a diamine, there can be industrially obtained: 1,3-diaminobenzene; 3,4′-diaminodiphenyl ether; 4,4′-diaminodiphenyl ether; 1,3-bis(3-aminophenoxy)benzene; 1,3-bis(4-aminophenoxy)benzene; 1,4′-bis(4-aminophenoxy) benzene; 2,2-bis[4-(4-aminophenoxy)phenyl]propane; 4,4′-bis(4-aminophenoxy)biphenyl; bis[4-(4-aminophenoxy)phenyl]sulfone; and bis[4-(3aminophenoxy)phenyl]sulfone. In addition, these combinations are preferable in particular, because there is provided excellent characteristics that a water absorption rate of the obtained thermoplastic polyimide is lowered; a dielectric rate is small; and a dielectric tangent is small, and an advantageous effect of increasing an adhesion strength which is an advantageous effect of the present invention is attained.

More preferable combinations include: for example, a combination of bisphenol A bis(trimellitic acid monoester acid anhydride) and 2,2-bis[4-(4-aminophenoxy)phenyl]propane; a combination of 3,3′,4,4′-biphenyltetracarboxylic acid dianhydride and ethylene bis(trimellitic acid monoester acid anhydride) and 2,2′-bis[4-(4-aminophenoxy)phenyl]propane; a combination of p-phenylene bis(trimellitic acid monoester acid anhydride) and 4,4′-diaminodiphenyl ether; and a combination of 4,4′-(4,4′-isopropylidenediphenoxy)bis (unhydrous phthalic acid) and 1,3-bis(3-aminophenoxy)benzene.

The thermoplastic polyimide for use in the present invention is obtained by imidizing the polyamic acid represented in general formula (1) above. For the imidization, either of a thermal cure technique and a chemical cure technique is used. The thermal cure technique is a method for accelerating an imidizing reaction by means of only heating without acting a dehydration and ring-closing agent or the like. In addition, the chemical cure method is a method for acting a chemical transfer agent (dehydrating agent) represented by an acidic anhydride such as an anhydrous acetic acid and a catalyst represented by a tertiary amine such as isoquinoline, β-picoline, pylidine, or the like on a polyamic acid organic solvent solution. Of course, the thermal cure method may be used with the chemical cure technique. The imidizing reaction condition can be varied depending on type of polyamic acid; thickness of film; selection of the thermal cure method and/or chemical cure method or the like. In the case where imidizing is carried out by using the chemical cure technique, the chemical transfer agent to be added to a polyamic acid composition can include: for example, an aliphatic acid anhydride; an aromatic acid anhydride; a N,N′-dialkyl carbodiamide; a lower aliphatic halide; a halide lower aliphatic halide; a halide lower aliphatic acid anhydride; an aryl phosphonic acid dihalide; a thionyl halide; or a mixture of two or more kinds thereof. Among them, it is preferable to use an aliphatic anhydride such as an anhydrous acetic acid, an anhydrous propionic acid; or an anhydric lactic acid or a mixture of two or more kinds thereof. In these chemical transfer agents, an amount of ×1 to ×10, preferably, an amount of ×1 to ×7, or more preferably an amount of ×1 to ×5 is added based on a molar number of a polyamic acid moiety in a polyamic acid solution. In addition, in order to effectively carry out imidizing, it is preferable to use a chemical transfer agent and a catalyst at the same time. As a catalyst, there is used an aliphatic tertiary amine, an aromatic tertiary amine, or a complex ring type, third class amine and the like. Among them, a heterocyclic tertiary amine is preferable in particular. Specifically, quinoline, isoquinoline, β-picoline, pylidine or the like are used. In these catalysis, a molar number of an amount of × 1/20 to ×10, preferably, an amount of × 1/15 to ×5, and more preferably, an amount of × 1/10 to ×2 are added based on a molar number of a chemical transfer agent. If the chemical transfer agent and catalyst are small in amount, there is tendency that imidizing effectively advances. Conversely, if they are too large in amount, there is tendency that imidizing is accelerated, making it difficult to handle them.

In the thermoplastic polyimide for use in the present invention, an inorganic or organic filler; a plasticizer such as an organic phosphor compound; and an antioxidant may be added in accordance with a publicly known method; and a thermosetting resin such as an epoxy resin, a cyanate resin, and a phenol resin may be mixed.

The non-thermoplastic polyimide film for use in the present invention can be prepared in accordance with a publicly known method. That is, this polyimide film can be obtained by flow casting or applying a polyamic acid to a support body, and carrying out chemical or thermal imidizing. It is preferable to carry out chemical imidizing from the viewpoint of film rigidity, breaking strength, and productivity.

Publicly known every kind of polyamic acid can be basically applied to the polyamic acid which is a precursor of the non-thermoplastic polyimide for use in the present invention. The polyamic acid is generally prepared by stirring the polyamic acid organic solvent solution obtained by dissolving at least one kind of an aromatic acid dianhydride and at least one kind of diamine in a substantially equal molar amount in organic solvent under a controlled temperature condition until polymerization of the acid dianhydride acid dianhydride and diamine has completed. In addition, the polyimide is obtained by imidizing the polyamic acid in the same way as the thermoplastic polyimide.

The acid anhydride suitable to synthesizing of the non-thermoplastic polyimide for use in the present invention can include an aromatic tetracarboxylic acid dianhydride such as: a pyromellitic acid dianhyride; 3,3′,4,4′-benzophenontetracarboxylic acid dianhydride; bis(3,4-dicarboxyphenyl) sulfone dianhydride; 2,2′,3,3′-biphenyltetracarboxylic acid dianhydride; 3,3′,4,4′-biphenyltetracarboxylic acid dianhydride; oxydiphthalic acid dianhydride; bis(2,3-dicarboxyphenyl)methane dianhydride; bis(3,4-dicarboxyphenyl) methane dianhydride; 1,1-bis (2,3-dicarboxyphenyl)ethane dianhydride; 1,1-bis(3,4-dicarboxyphenyl)ethane; 1,2-bis(3,4-dicarboxyphenyl)ethane dianhydride; 2,2-bis(3,4-dicarboxyphenyl)propane dianhydride; 1,3-bis (3,4-dicarboxyphenyl)propane dianhydride; 4,4′-hexafluoroisopropylidene diphthalic acid anhydride; 1,2,5,6-naphthalenetetracarboxylic acid dianhydride; 2,3,6,7-naphthalenetetracarboxylic acid dianhydride; 3,4,9,10-perylenetetracarboxylic acid dianhydride; p-phenylene bis(trimellitic acid monoester acid anhydride); ethylene bis(trimellitic acid monoester acid anhydride); bisphenol A bis(trimellitic acid monoester acid anhydride); 4,4′-(4,4′-isopropylidenediphenoxy)bis(anhydrous phthalic acid); p-phenylenediphthalic acid anhydride or an analogous thereof.

Among them, pyromellitic acid dianhydride; oxydiphthalic acid dianhyride; 3,3′,4,4′-benzophenontetracarboxylic acid dianhydride; 3,3′,4,4′-biphenyltetracarboxylic acid dianhydride; or p-phenylenebis(trimellitic acid monoester acid anhydride) is preferable, and they can be used alone or in mixture with an arbitrarily rate.

The diamine suitable to synthesizing of the non-thermoplastic polyimide for use in the present invention can be include: 1,4-diaminobenzene(p-phenylenediamine); 1,3-diaminobenzene; 1,2-diaminobenzene; benzidine; 3,3′-dichlorobenzidine; 3,3′-dimethylbenzidine; 3,3′-dimethoxybenzidine; 3,3′-dihydroxybenzidine; 3,3′,5,5′-tetramethylbenzidine; 4,4′-diaminodiphenylpropane; 4,4′-diaminodiphenylhexafluoropropane; 1,5-diaminonaphthalene; 4,4′-diaminodiphenyldiethyl silane; 4,4′-diaminodiphenyl silane; 4,4′-diaminodiphenylethyl phosphine oxide; 4,4′-diaminodiphenyl N-methylamine; 4,4′-diaminodiphenyl N-phenylamine; 4,4′-diaminodiphenyl ether; 3,4′-diaminodiphenyl ether; 3,3′-diaminodiphenyl ether; 4,4′-diaminodiphenyl thioether; 3,4′-diaminodiphenyl thioether; 3,3′-diaminodiphenyl thioether; 3,3′-diaminodiphenylmethane; 3,4′-diaminodiphenylmethane; 4,4′-diaminodiphenylmethane; 4,4′-diaminodiphenyl sulfone; 3,4′-diaminodiphenyl sulfone; 3,3′-diaminodiphenyl sulfone; 4,4′-diaminobenzanilide; 3,4′-diaminobenzanilide; 4,4′-diaminobenzophenon; 3,4′-diaminobenzophenon; 3,3′-diaminobenzophenon; bis[4-(3-aminophenoxy)phenyl]methane; bis[4-(4-aminophenoxy)phenyl]methane; 1,1-bis[4-(3-aminophenoxy)phenyl]ethane; 1,1-bis[4-(4-aminophenoxy)phenyl]ethane; 1,2-bis[4-(3-aminophenoxy)phenyl]ethane; 1,2-bis[4-(4-aminophenoxy)phenyl]ethane; 2,2-bis[4-(3-aminophenoxy) phenyl]propane; 2,2-bis[4-(4-aminophenoxy)phenyl]propane; 2,2-bis[4-(3-aminophenoxy)phenyl]butane; 2,2-bis[3-(3-aminophenoxy)phenyl]-1,1,1,3,3,3-hexafluoropropane; 2,2-bis[4-(4-aminophenoxy)phenyl]-1,1,1,3,3,3-hexafluoropropane; 1,3-bis(3-aminophenoxy)benzene; 1,4-bis(3-aminophenoxy)benzene; 1,4′-bis(4-aminophenoxy)benzene; 4,4′-bis(4-aminophenoxy)biphenyl; 4,4′-bis(3-aminophenoxy)biphenyl; bis[4-(3-aminophenoxy)phenyl]ketone; bis[4-(4-aminophenoxy)phenyl]ketone; bis[4-(3-aminophenoxy)phenyl]sulfide; bis[4-(4-aminophenoxy)phenyl]sulfide; bis[4-(3-aminophenoxy)phenyl]sulfone; bis[4-(4-aminophenoxy)phenyl]sulfone; bis[4-(3-aminophenoxy)phenyl]ether; bis[4-(4-aminophenoxy)phenyl]ether; 1,4-bis[4-(3-aminophenoxy)benzoyl]benzene; 1,3-bis[4-(3-aminophenoxy)benzoyl]benzene; 4,4′-bis[3-(4-aminophenoxy)benzoyl]diphenyl ether; 4,4′-bis[3-(3-aminophenoxy)benzoyl]diphenyl ether; 4,4′-bis[4-(4-amino-α,α-dimethylbenzyl)phenoxy]benzophenone; 4,4′-bis[4-(4-amino-α,α-dimethylbenzyl)phenoxy]diphenyl sulfone; bis[4-{4-(4-aminophenoxy)phenoxy}phenyl] sulfone; 1,4-bis[4-(4-aminophenoxy)-α,α-dimethylbenzyl]benzene; 1,3-bis[4-(4-aminophenoxy)-α,α-dimathylbenzyl]benzene; 4,4′-diaminodiphenylethyl phosphine oxide; or an analogous thereof.

Among them, 4,4′-diaminephenyl ether; 4,4′-diaminobenzanilide; p-phenylenediamine; or a mixture thereof is preferable in particular.

Preferable combinations of acid dianhydride and diamine include: a combination of pyromellitic acid dianhydride and 4,4′-diaminodiphenyl ether; a combination of pyromellitic acid dianhydride, 4,4′-diaminodiphenyl ether and p-phenylenediamine; a combination of piromellitic acid dianhydride, p-phenylene bis(trimellitic acid monoester acid anhydride), 4,4′-diaminodiphenyl ether and p-phenylenediamine; a combination of p-phenylenediamine and 3,3′,4,4′-biphenyltetracarboxylic acid dianhydride; and a combination of pyromellitic acid dianhydride, p-phenylene bis(trimellitic acid monoester acid anhydride), 3,3′,4,4′-biphenyltetracarboxylic acid dianhydride, 4,4-diaminodiphenyl ether and p-phenylenediamine. The non-thermoplastic polyimide synthesized by combining these monomers develops a proper elasticity, dimensional stability, and low water absorption rate or the like, and is suitable for use in a variety of laminates according to the present invention.

A preferred solvent for synthesizing the polyamic acid includes: an amide solvent, i.e., N,N-dimethylformamide; N,N-dimethylacetamide; or N-methyl-2-pyrrolidone and the like. N,N-dimethylformamide is preferably used in particular.

A method for forming a thermoplastic polyimide layer on a surface of a non-thermoplastic polyimide film is typically a method for flow casting or applying a polyamic acid which is a precursor of the thermoplastic polyimide, for example, the polyamic acid as shown in general formula (1), on one face or both faces of the non-thermoplastic polyimide film; followed by imidizing in a thermal method or a chemical method and drying the polyamic acid to obtain a polyimide film. In addition, in the case where the thermoplastic polyimide is soluble in a solvent, a polyimide film can be obtained by applying that solution onto a non-thermoplastic polyimide and drying it. Alternatively, a method which comprises making a thermoplastic polyimide sheet and bonding it to a non-thermoplastic polyimide film can be used.

To the polyimide film obtained by the variety of methods, an inorganic or organic filler, a plasticizer such as an organic phosphorous compound and an antioxidant may be added in accordance with a publicly known method.

In the case where the non-thermoplastic polyimide layer and the thermoplastic polyimide layer are used altogether, it is preferable that the thickness of the thermoplastic polyimide layer be at most 10 μm to at least 0.01 μm. It is more preferable that the thickness be at most 5 μm to at least 0.1 μm. If the thermoplastic polyimide layer is too thin, there is tendency that an advantageous effect of developing adhesion property which is an advantageous effect of the present invention becomes weak. On the other hand, if the layer is too thick, the physical property such as heat resistance or thermal expansion property of a printed circuit board is dependent on the physical property of the thermoplastic polyimide. Therefore, in order to utilize the physical property of the non-thermoplastic polyimide film having excellent property as a printed circuit board, it is preferable that the thickness of the thermoplastic polyimide layer be thinner than he non-thermoplastic polyimide film. More preferably, the thickness of the thermoplastic polyimide layer should be at most ½ of the non-thermoplastic polyimide layer. Further preferably, the thickness should be at most ⅕ thereof.

It is preferable that 10-point average roughness (hereinafter, referred to as Rz) of the thermoplastic polyimide layer surface be at most 2 μms, it is further preferable that the roughness be at most 1 μm. A smooth surface is suitable to form a high density circuit having a line/space of 25 μm/25 μm and is suitable in view of the fact that no etching remnant occurs with irregularities of a resin surface. Rz is defined under a standard relating to a surface shape such as JIS B0601. For measurement of the surface shape, there can be used: sensing pin type surface roughness meter of B0651 or lightwave interfering type surface roughness meter of B0652. In the present invention, 10-point source roughness of the thermoplastic polyimide layer surface was measured by using a lightwave interfering type surface roughness meter (NewView 5030 system available from ZYGO Co., Ltd.).

On the other hand, the thickness of the non-thermoplastic polyimide film is preferably at least 2 μm to at most 125 μm, and more preferably at least 5 μm to at most 75 μm. If the thickness is smaller than this range, there is tendency that the rigidity of a laminate is insufficient, and it is difficult to handle a film. Thus, an advantage of the non-thermoplastic polyimide layer is hardly utilized. On the other hand, if the film is too thick, it is necessary to increase a circuit width as the thickness of the insulation layer becomes thick from the viewpoint of impedance control when preparing a printed circuit board. Thus, such a too thick film is against a request for downsizing and making dense a printed circuit board.

For a metal layer according to the present invention, copper, nickel, cobalt, chrome, titanium, molybdenum, tungsten, zinc, tin, indium, hold or an alloy thereof is preferably used from the viewpoint of improving adhesion property associated with thermoplastic polyimide. In particular, nickel, chrome, or an alloy thereof is preferable in that its high advantageous effect is high and these elements can be industrially obtained.

Methods for forming a metal layer can include: physical vapor deposition techniques such as: a vacuum vapor deposition method; an ion plating method; a sputtering method, and EB vapor deposition method; and chemical method such as electroless plating and chemical vapor deposition method. Among the physical vapor deposition methods, sputtering is preferable in comprehensive view of simplicity of equipment, productivity, and adhesion property between a conductor layer and a film. It is preferable that the thickness of the metal layer be at least 5 nm to at most 500 nm.

A precise uniform metal thin film can be prepared obtained by using the sputtering method. However, in general, in a copper or copper alloy thin film formed in accordance with the sputtering method, strong adhesion property cannot be achieved on non-thermoplastic polyimide film having excellent surface flatness. In our discussion as well, adhesion property of 2N/cm or more was not successfully achieved on a non-thermoplastic polyimide film whose surface property is at most 3 μm in Rz value. However, using a laminate having a thermoplastic polyimide layer according to the present invention, remarkable improvement in adhesion property is observed, and adhesion property of 5N/cm can be achieved.

A publicly known method can be applied in the case where sputtering is used. That is, a DC magnetron sputtering, Rf sputtering or a method variously improved therefor can be properly applied according to their respective requests. The DC magnetron sputtering is preferred in order to efficiently sputter a conductor such as nickel or copper. In addition, the RF sputtering is suitable in the case where sputtering is carried out in a high vacuum for the purpose of preventing entry of sputtering gas to a thin film.

Now, the DC magnetron sputtering will be described here. First, a polyimide film is set as a substrate in a vacuum chamber, and is vacuum-drawn. In general, vacuum-drawing is carried out until 6×10⁻⁴ Pa or less by combination of a rough drawing using a rotary pump and a diffusion pump or a cryopump. Next, sputtering gas is introduced, and the inside of the chamber is set to 0.1 Pa to 10 Pa, preferably 0.1 Pa to 1.0 Pa in pressure. Then, a DC voltage is applied to a metal target, thereby generating plasma discharge. At this time, a magnetic field is formed on the target, and the generated plasma is closed in the magnetic field, thereby improving sputtering efficiency for the target of plasma particles. While the polyimide film is prevented from being affected by the plasma and sputtering, the target is maintained from several minutes to several hours in a state in which plasma is generated, and a surface oxidized layer of the metal target is removed (hereinafter, referred to as “pre-sputtering”). After pre-sputtering has terminated, sputtering is carried out for a polyimide film, for example, by opening a shutter. The discharge power during sputtering preferably ranges from 100 W to 1000 W. In addition, batch type sputtering or roll type sputtering is applied according to a form of sample for supptering. Although inert gas such as argon is generally used as introduced sputtering gas, a mixture gas including a small amount of oxygen or any other gas can also be used.

In addition, a publicly known method can be applied as an electroless plating method. A variety of electroless plating treatment agents are commercially available. In the respective treatment steps, the relating electroless plating agent manufacturers each disclose its recommended conditions. However, in general, each of the electroless plating agents is experimentally used by normalizing a concentration, a treatment temperature, and a treatment time according to individual applicable resins. Table 1 shows an example of a condition of an electroless plating treatment step for a thermoplastic polyimide resin according to the present invention.

TABLE 1

| Treatment | | | |
|---|---|---|---|
| steps | Prescription of treatment agents | | Condition |
| 1 | Cleaner Securigant 902(*) | 40 ml/l | 60° C., |
| | Cleaner Additive 901(*) | 3 ml/l | 5 minutes |
| | sodium hydroxide | 20 g/l | |
| | (Wash by water) | | |
| 2 | Primitive Neogant B(*) | 20 ml/l | 1 minute |
| | Sulfuric acid | 1 ml/l | in room |
| | | | temperature |
| 3 | Activator Neogant 834 Konk(*) | 40 ml/l | 40° C., |
| | Sodium hydroxide | 4 g/l | 5 minutes |
| | Boric acid | 5 g/l | |
| | (Wash by water) | | |
| 4 | Reducer Neogant(*) | 1 g/l | 2 minutes |
| | Sodium hydroxide | 5 g/l | in room |
| | | | temperature |
| | (Wash by water) | | |
| 5 | Basic Solution Print | 80 ml/l | 35° C., |
| | Gant MSK-DK(*) | | 15 minutes |
| | Copper Solution Print Gant MSK(*) | 40 ml/l | |
| | Stabilizer Print Gant MSK-DK(*) | 3 ml/l | |
| | Reducer copper(*) | 14 ml/l | |
| | (Wash by water) | | |

(*)Available from Atotech Japan Co., Ltd.

The thermoplastic polyimide resin for use in the present invention can be brought into good contact with an electrolessly plated copper. Although the plating thickness can be properly selected according to use of a laminate using it, it is generally preferable that the thickness be in the range of about 0.1 μm to 10 μm. If the plating thickness is smaller than this range, there is tendency that the plating does not precipitate a surface uniformly. In addition, if the thickness is too great, it takes long to carry out plating treatment, and there is tendency that it is disadvantage to form a thin line circuit. In particular, it is preferable that a thickness ranges from 0.2 μm to 1.0 μm for plating reliability and thin line circuit forming property. In the condition shown in Table 1, the plating thickness is 0.3 μm. In addition, when nickel or cobalt is electrolessly plated, there is an advantageous effect that diffusion such as copper or the like to a thermoplastic polyimide resin layer is prevented.

In addition, a printed circuit board preparing method for laminating an adhesive layer on a non-thermoplastic polyimide film and a circuit face of an inner layer circuit board formed a circuit to be opposed to each other, followed by carrying out panel plating in accordance with the above described physical vapor deposition method, the physical vapor deposition method is a dry treatment, and thus, there is no apprehension that problem occurs with environment contamination which has been problematic in a conventional wet type electroless plating method. In addition, in the panel plated layer in accordance with the physical vapor deposition method, it is necessary that at least the outermost surface layer has conductivity. This is because the panel plated layer serves as a feeding layer in an electroplating step when preparing a printed circuit board. In addition, in the electroplating step, it is necessary that a plated layer is formed in uniform thickness at a required portion over full regions of a work size of the printed circuit board. In order to achieve this, it is required that an electrical resistance of the feeding layer is low, and therefore, it is necessary to form a panel plated layer having proper thickness. In this preparing method, it is preferable that the thickness of the metal layer serving as an feeding layer of electroplating is at least 25 nm to at most 3000 nm. Further preferably, the thickness should be at least 50 nm to at most 1500 nm. If the thickness is smaller than 250 nm the electrical resistance increases. The thickness of the electrolytic plated layer formed when carrying out electrolytic plating can be uneven in a face. On the other hand, if the thickness is greater than 3000 nm, the productivity is lowered when a metal layer is formed by means of panel plating in the physical vapor deposition method.

It is preferable that the metal layer be structured to be two-layered in order to further improve adhesion of the metal layer. That is, the metal layer has a first metal layer formed on a thermoplastic polyimide layer and a second metal layer formed on the first metal layer.

As metal species of the first metal layer, it is preferred to use nickel, cobalt, chrome, titanium, molybdenum, tungsten, zinc, tin, indium, gold or an alloy thereof. Among them, nickel, chrome, gold, or titanium is preferred in that adhesion property with thermoplastic polyimide is improved more remarkably. Further, nickel or an alloy of nickel and chrome is further preferred in that its advantageous effect is high and they can be industrially obtained.

It is preferable that metal species of the second metal layer comprise copper or an alloy thereof. Copper or an alloy thereof is low in electrical resistance as compared with the metal species used for the first metal layer. Thus, it becomes possible to reduce the thickness of the whole metal layer as compared with a case in which the metal layer is single and the productivity is high when forming the metal layer, which is industrially advantageous. In addition, when copper or an alloy thereof is used as the second metal layer, the adhesion with subsequent electrolytic plated copper becomes high, which is preferable.

Rigid adhesion property of at least 10 N/cm can be achieved by providing the first metal layer and thermoplastic polyimide layer. In particular, even after pressure cooker test, such provision has excellent adhesion strength of at least 5N/cm is provided, and is sufficiently durable in a treatment such as de-smearing and chemical plating.

It is preferable that the thickness of the first metal layer be at least 1 nm to at most 50 nm. It is more preferable that the thickness is at least 3 nm to at most 20 nm. If the thickness is smaller than this range, there is a case in which an advantageous effect of improving adhesion property is insufficient. On the other hand, if the thickness is greater than this range, there is tendency that the productivity is lowered when forming the metal layer. The thickness of the second metal layer should be preferably at least 10 nm to at most 1000 nm; further preferably at least 20 nm to at most 500 nm; and particularly preferably at least 30 nm to at most 300 nm. In the case where the adhesive layer on the above described non-thermoplastic polyimide film and the circuit face of the inner layer circuit board formed a circuit are laminated to be opposed to each other, and then, panel plating is carried out in accordance with a physical vapor deposition method, it is preferable that the thickness of the second metal layer at least 50 nm to at most 2500 nm; and it is more preferable that the thickness be at least 100 nm to at most 1000 nm. If the thickness is smaller than this range, there is tendency that an object of reducing an electrical resistance cannot be sufficiently achieved. On the other hand, if the thickness is greater than this range, there is tendency that the productivity is lowered when forming the metal layer.

A total of thickness of these metal layers should be comprehensively judged from the viewpoint of <1> cost efficiency; <2> etching property for removing a feeding layer in the case of forming a circuit in accordance with a semi-additive method; <3> etching property in the case where a circuit having width of at most 30 μm is formed in accordance with a subtractive method; and <4> thickness required to obtain uniform thickness of the plated layers on a whole panel region in an electrolytic plating step when preparing preparing a printed circuit board. That is, it is required that the thickness is as small as possible from the viewpoints of <1> to <3>, whereas it is required that the thickness is great from the viewpoint of <4>. Therefore, the thickness should be properly selected in view of a desired circuit width, the size of the whole panel region or the like. Preferably, the thickness should be at most 1000 nm; further preferably, it should be at most 500 nm; and particularly preferably, it should be at most 300 nm. If the thickness is greater than 1000 nm, the etching property is impaired, and there is tendency that it becomes difficult to form a high density circuit pattern.

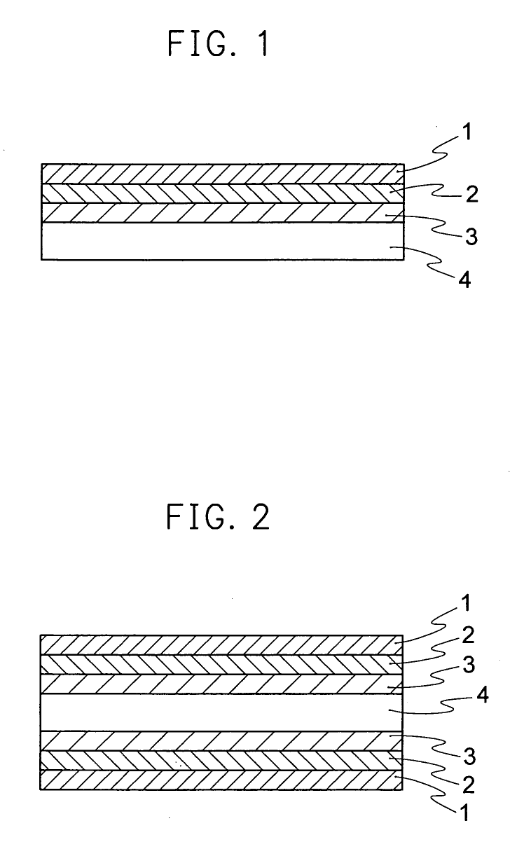

FIG. 1 shows a laminate according to the present invention in which a thermoplastic polyimide layer 3 is provided on one face of a non-thermoplastic polyimide film 4, and a first metal layer 2 and a second metal layer 1 are formed on a surface of the thermoplastic polyimide layer 3. FIG. 2 shows a laminate according to the present invention in which a thermoplastic polyimide layer 3 is provided on both faces of a non-thermoplastic polyimide film 4, and a first metal layer 2 and a second metal layer 1 are formed on each surface of the thermoplastic polyimide layer 3.

A method of further improving adhesion between the metal layer and polyimide film include a method of, while heating a thermoplastic polyimide layer, forming the metal layer in accordance with one or more methods selected from a sputtering method, a vacuum vapor deposition method, an ion plating method, an EB vapor deposition method, and a chemical vapor deposition method. Heating is carried out by a red infrared-ray lamp heater, heating roll using a heating medium or a electric heat line and inductive heating using electromagnetic waves. Among them, red infrared-ray lamp heater and heating roll using the heating medium or electric heat line is preferable in that its structure is simple, small in size, and can be mounted comparatively easily in a vacuum vessel. It is preferable that a heating temperature be at least 100° C., and it is further preferable that the temperature be in the range of 100° C. and 300° C. If the temperature is lower than this range, advantageous effect of heating is small. On the other hand, if the temperature is higher than this range, degradation, deformation, or decomposition of a thermoplastic polyimide resin may occur, which is not preferable. Among them, heating at least a glass transition temperature of a thermoplastic polyimide resin is more preferable because a molecular movement of the thermoplastic polyimide resin becomes active, and adhesion force with metal elements to be deposited is improved.

In addition, another method for further improving adhesion between the metal layer and polyimide film can include: applying publicly known physical surface treatment such as ion bomber treatment or chemical surface treatment such as primer treatment. Among them, it is preferable to use a method for treating a surface of a thermoplastic polyimide layer by combining one or more treatments selected from an ion gun treatment, a plasma treatment, a corona treatment, a coupling agent treatment, a permanganate treatment, a ultraviolet-ray emitting treatment, an electron beam emitting treatment, a surface treatment by colliding an abrasive at a high speed, a firing treatment, and a hydrophilization treatment.

In the ion gun treatment, ion gun ionizes the gas introduced in a plasma discharge chamber, and emits an ion beam onto a substrate by two grids, i.e., a screen grid focusing positively charged beams, and an accelerator grid applied negatively voltage for leading out ion beams. As a specific ion gun device, a filament cathode ion source (model name: 3-1500-100FC) and an ion source power supply (MPS3000) available from Ion Tech Co. Ltd. can be used. Argon gas is preferred as the gas. In the case where argon is used as the gas, its operating condition is such that a discharge voltage required for ionization should be in the range of 30 V to 60 V or should be preferably in the range of 35 V to 40 V; the pressure in the chamber should be in the range of 1×10⁻³ Pa to 1×10⁻¹ Pa or should be preferably in the range of 2×10⁻² Pa to 6×10⁻² Pa; the beam voltage should be in the range of 200 V to 1000 V or should be preferably in the range of 300 V to 600 V; and an acceleration voltage should be in the range of 200 V to 1000 V or should be preferably in the range of 300 V to 600 V.

In the plasma treatment, a plasma treatment device is maintained at a predetermined gas pressure when a gas having a proper composition is introduced. When electric discharge is started, the plasma treatment device is configured so that plasma is generated in the device. At this time, a gas composition and a gas pressure are properly selected so that a grow discharge can be obtained. Here, although the gas pressure in an atmosphere for carrying out a plasma treatment is not limited in particular, it is preferable that the treatment be carried out under a pressure ranging from 10000 Pa to 1000000 Pa. If the pressure is less than 10000 Pa, a vacuum device or the like is required. If the pressure exceeds 1000000 Pa, discharging is hardly carried out. In particular, it is preferable that the plasma treatment be carried out under an atmospheric pressure because workability and productivity of plasma treatment are improved. In addition, although the gas composition of plasma treatment is not limited in particular, a single gas of a rare gas element or a mixture gas is preferably used because glow discharge is achieved in 10000 Pa to 1000000 Pa. The preferred gas composition is a composition of Ar/He/N₂. Although a state in which the air in the device is substituted by the rare gas element is preferable in particular, air may be entered to an extent such that glow discharge is not inhibited. The treatment density is in the range such that a resin surface can be chemically modified to introduce a hydrophilic functional group (such as a hydroxide group, a carboxylic acid group, or a carbonyl group), and is in the range of 10 to 100000 [W·minute/m²] or preferably in the range of 100 to 10000 [W·minute/m²]. The hydrophilic property of the surface can be improved without degrading a resin by carrying out treatment at a density of this range.

With respect to the corona treatment, a corona electrode is formed at a length at which a corona treatment should be carried out, in other words, at a width of a thermoplastic polyimide resin film. A thermoplastic polyimide resin film travels along a roll between a roll insulated at a high level and a striated corona electrode. Then, corona discharge is generated by acting high energy on the corona electrode, whereby a corona discharge treatment can be applied to the thermoplastic polyimide resin film. At this time, the electric power density of the corona discharge treatment is in the range of 10 to 100000 [W·minute/m²], and further preferably in the range of 100 to 10000 [W·minute/m²]. The density is experimentally properly set according to type or thickness of resin. In addition, a material for an electrode is not limited in particular, and experimentally properly selected and set. When a corona discharge treatment is carried out, extension is applied in a film widthwise direction in order to prevent wrinkles caused by thermal expansion of a film, and then, the corona discharge treatment may be carried out once or a plurality of times. In addition, following the corona discharge treatment, ionized gas having ions whose polarity is opposite to that of static electricity charged with the film is blown to the film so as to remove static electricity.

With respect to the coupling agent treatment, a method for adhering a coupling agent solution can include: a method for applying a coupling agent solution onto a resin surface; rubbing the resin surface with the coupling agent solution; blowing the coupling agent solution onto the resin surface; immersing the resin in the coupling agent solution or the like. In addition, the coupling agent for use in the present invention can include: for example, a silane coupling agent; a titanate coupling agent; an aluminum coupling agent; or zirconium coupling agent. These coupling agents may be used independently or may be used by mixing several types of the agents. The agents can be experimentally set. Among them, it is preferable to use a silane coupling agent. In particular, an amino silane coupling agent is preferred. These agents have a reactive group (such as a methoxy group or an ethoxy group) having coupling property with a surface component of a thermoplastic polyimide resin and a reactive group (such as acrylic group, an amino group, or epoxy group) having coupling property with a metal layer component in a molecule to mediate (couple) a bond of a film and a metal layer, and enhance an affinity between them. Such a coupling agent specifically can include, in a silane coupling agent, an acryl silane coupling agent such as γ-methacryloxypropyltrimethoxy silane; γ-methacryloxypropyltriethoxy silane; γ-methacryloxypropylmethyldimethoxy silane; γ-methacryloxypropylmethyldiethoxy silane; γ-acryloxypropyltrimethoxy silane; γ-acryloxypropylmethyldimethoxy silane or the like. In addition, it can include an amino silane coupling agent such as γ-aminopropyltrimethoxy silane; γ-aminopropyltriethoxy silane; γ-aminopropylmethyldimethoxy silane; γ-aminopropylmethyldiethoxy silane; N-phenyl-γ-aminopropyltrimethoxy silane; N-(phenylmethyl)-γ-aminopropyltrimethoxy silane; N-methyl-γ-aminopropyltrimethoxy silane; N,N, N-trimethyl-γ-aminopropyltrimethoxy silane; N,N, N-tributyl-γ-aminopropyltrimethoxy silane; N-β(aminoethyl) γ-aminopropyltrimethoxy silane; N-β(aminoethyl) γ-aminopropylmethyldimethoxy silane; N-β(aminoethyl) γ-aminopropyltriethoxy silane; N-ω(aminohexyl) γ-aminopropyltrimethoxy silane; N{N′-β(aminoethyl)}-β (aminoethyl) γ-aminopropyltrimethoxy silane or the like. In addition, it can include an epoxy silane such as β(3,4-epoxycyclohexyl)ethyltrimethoxy silane; γ-glycidoxypropyltrimethoxy silane; γ-glycidoxypropyltriethoxy silane; γ-glycidoxypropylmethyldiethoxy silane; γ-glycidoxypropylmethyldimethoxy silane or the like. In addition, in a titanate coupling agent, it can include: isopropyltriisostearoyl titanate; isopropyltridodecylbenzene sulfonyl titanate; isopropyltris (dioctylpyrophosphate)titanate; tetraoctyl bis(ditridecyl phosphite) titanate; tetraisopropyl bis(dioctylphosphite)titanate; tetra(2,2-diallyloxymethyl-1-butyl)bis(ditridecyl)phosphite titanate; bis(dioctylpyrophosphate)oxyacetate titanate; bis (dioctylpyrophosphate) ethylene titanate; isopropyltrioctanoyl titanate; isopropyldimethacrylisostearoyl titanate; isopropylisostearoyldiacryl titanate; isopropyltri(dioctylphophate)titanate; isopropyl tricumylphenyl titanate; isopropyltri(N-aminoethyl-aminoethyl)titanate; dicumylphenyloxyacetate titanate; diisostearoylethylene titanate or the like. And others, in aluminum coupling agent, it can include alkylacetoacetate-aluminum-diisopropylate, and in a zirconium coupling agent, it can include zirconium tributhoxy stearate. The coupling agent is used as a solution by dissolving it in a solvent. The solvents can include an alcohol solvent such as methanol; ethenol; propanol; isopropanol; and solmix which is a mixture solvent thereof; a ketone solvent such as acetone, MEK, 2-pentanon, 3-pentanone and the like; and an aromatic hydrocarbon solvent such as toluene, xylene and the like. These solvents may be used independently, may be used by mixing them or may be used with water. In particular, methanol is preferably used. In addition, it is preferable that the concentration of the coupling agent solution be in the range of 0.005% by weight to 30% by weight. It is further preferable that the concentration is in the range of 0.01% by weight to 5% by weight. If the concentration of the coupling agent is too high, irregularities are observed on a surface of a thermoplastic polyimide resin, and there is tendency that such irregularities are not preferable in view of appearance. Conversely, if the concentration of the coupling agent is too low, there is tendency that sufficient advantageous effect is not developed. In this way, the coupling agent solution is uniformly applied onto a resin surface, whereby a resin surface component and the coupling agent react with each other; a film of the coupling agent is formed on the resin surface; and the surface property of the resin can be made uniform. Such a coating method can include: a roll coater method using a roll; a spreader method using a doctor knife; a Mayor bar coating; a gravure roll coating; reverse roll coating; brush coater method; an air blade method; spray coater method; a curtain coater method; an immersion coater method and other various method, and coating may be carried out by any coating method. Then, a thermoplastic polyimide resin whose surface property is made uniform by applying the coupling agent solution in accordance with the treatment step is guided to a drying furnace. Then, the step of drying the solution adhered to the resin surface is carried out. A drying condition is not limited in particular, and is experimentally properly set.

In the permanganate treatment, it is preferable to use sodium permanganate or potassium permanganate as a permanganate. It is desirable that its concentration is at least 0.1 mol/L. This is because, if the concentration is lower than 0.1 mol/L, the activation capacity to a substrate surface on which heat treatment has been applied is lowered, and a treatment time is further extended. In addition, there is tendency that it becomes difficult to uniformly carry out surface treatment. In addition, an upper limit of the concentration is not limited in particular, and up to saturation concentration can be set. However, it is preferred to use this salt on an alkali side from the viewpoint of advantageous effect of surface activation to a thermoplastic polyimide resin.

With respect to the ultraviolet-ray emitting treatment, surface treatment using ultraviolet-ray emission has two effects of remodeling and washing. As in the present invention, in the case where a target is an organic substance, a functional group having an oxygen rich polarity is generated by means of ultraviolet-ray emission. A low pressure mercury lamp, an excimer lamp and the like is suitable for surface treatment. The low pressure mercury lamp is preferred in terms of cost efficiency, specificity of radiant ultraviolet ray, and a low temperature of the lamp tube wall. The low pressure mercury lamp is 185 nm and 254 nm in wavelength of its resonance line. The ultraviolet ray having a wavelength of 185 nm decomposes an oxygen molecule in air to generate ozone. This ozone absorbs a ultraviolet ray having a wavelength of 254 nm, and is decomposed to be an excitation oxygen atom. Then, this excitation oxygen atom activates a surface to be treatmented. In addition, the ultraviolet ray separates a molecule on an organic substance surface and easily extracts a light hydrogen atom, and at the same time, a hydrophilic group is generated by the presence of the generated excitation oxygen atom. The low pressure mercury lamp is commercially available and applicable for use as that having an output of about 25 W to 400 W. As the treatment condition, it is preferable that emission time be in the range of 10 seconds to 10 minutes and a luminance be in the range of of 1 mW/cm² to 30 mW/cm²; and it is more preferable that the emission time be in the range of 1 minute to 5 minutes and luminance be in the range of 10 mW/cm² to 20 mW/cm² in view of treatment strength or stability.

With respect to the above described electron beam emitting treatment, when an electron collides with an organic substance molecule, ionization or excitation takes place, and a radical generates in a resin. Then, this radical starts reaction, and cross-liking takes place. On the other hand, the stoppage of growth due to deactivation of a growth chain between the radicals and movement of an active point also take place. In this way, the radical concentration increases due to the electron beam emitting treatment, and thus, polymerization is momentarily completed. As a result, there can be obtained a laminate having high cross-linking density, excellent chemical resistance, environment durability or the like. The electron beam emitting device heats a cathode which comprises a tungsten filament to generate a thermal electron in a high vacuum. A negative high voltage is applied to that cathode filament portion, whereby an electron is offended, and is accelerated at a high speed. Then, that electron is discharged in air or inert gas through a thin metal foil located at a grounding electric potential. This discharged electron is emitted to an object targeted to be treated. It is preferable that the electron acceleration voltage be in the range of 100 kV to 500 kV. It is more preferable that the voltage is in the range of 150 kV to 250 kV from the view of treating stability and strength. It is preferable that an electron flow be in the range of 10 mA to 500 mA. It is preferable that a dose is in the range of 10 kGy to 1000 kGy, and it is more preferable that the dose is in the range of 100 kGy to 500 kGy from the viewpoint of treating stability and reduction of harmful damage to the resin.

Surface treatment by colliding the abrasive at a high speed will be described by way of example of a sand blast treatment spraying a resin surface with silica sand or other sands by means of compressed air or centrifugal force. The sand blast treatment is defined as a method for increasing a contact area between a film and an adhesive by forming irregularities on the resin surface, and at the same time, improving adhesion property by removing WBL or contaminated layer on the resin surface. A sand blast treating device comprises: a sand blast spraying nozzle for spraying with an abrasive; an adjustment valve for adjusting a spray quantity (blast quantity) from the nozzle; a hopper for storing the abrasive; and an air chamber for sending out compressed air. In addition, the sand blast spraying nozzle is movable so as to adjust an angle and a gap relevant to a thermoplastic polyimide resin (blast angle and blast distance). Then, the blast quantity, the blast angle, and the blast distance are set in an optimal condition so that the sand blast treatment can be carried out. Depending on location the blowing nozzle, both sides as well as one side of the resin can be treated. In addition, the abrasive may be sprayed onto the resin surface by means of compressed air in this way, or may be stroked onto the resin surface by means of a vane which rotates at a high speed. With respect to such a treatingt condition of the sand blast treatment, although there is a need for setting such a condition such that no abrasive and material targeted to be grinded remains on the thermoplastic polyimide resin surface and the strength of the thermoplastic polyimide resin is not lowered, the treating condition can be experimentally properly set. Specifically, a silica sand or other abrasive is used as an abrasive. It is preferable to use silica sand having particle size of 0.05 mm to 10 mm, and it is further preferable to use silica sand having particle size of 0.1 mm to 1 mm. In addition, it is preferable that the blast distance be in the range of 100 mm to 300 mm. It is preferable that the blast angle is in the range of 45 degree to 90 degree, and it is further preferable that the angle be in the range of 45 degree to 60 degree. It is preferable that the blast quantity is in the range of 1 kg/minute to 10 kg/minute. This is because the abrasive or material targeted to be grinded is prevented from remaining on the thermoplastic polyimide resin surface due to the sand blast treatment, and further, the grinding depth is controlled. It is preferable that the grinding depth be within the range of 0.01 μm to 0.1 μm. In this manner, the lowering of the resin strength can be prevented. As an abrasive, grinding grains having higher hardness than the thermoplastic polyimide resin may be used. As surface treatment by colliding the abrasive at a high speed, in addition to the above described sand blast treatment, it is possible to use a method such as shot blast, shot peening or liquid honing. A shot plast or shot peening is a method using hard grains (shot) in stead of sand as an abrasive, and the blast angle, blast distance, blast quantity, hardness of hard grains, degree of grain or the like may be normalized. In addition, liquid honing is a method for ejecting these abrasives together with liquid at a high speed. In the case where the abrasives are steel grains, a mixture of these steel grains in water to which a antirust has been added is used. Advantageous effect similar to that of the sand blast treatment can be obtained by these methods.

In the above described firing treatment, the treating device comprises: a firing treatment nozzle for blowing a flame onto a surface of a thermoplastic polyimide resin; and a cooling roll for cooling the resin, and is configured so as to enable a firing treatment while minimizing an effect of a heat on the resin. The firing treatment condition is not limited in particular, and a condition such that a resin is not degraded may be selected. Although such a condition can be experimentally properly selected, it is preferable that a flame of 1000° C. to 2000° C. be used and treatment be carried out while winding a base material around the cooling roll in order to minimize an effect of a heat on the base material. It is preferable that the cooling roll temperature is in the range of 10° C. to 100° C., and it is further preferable that the temperature is in the range of 20° C. to 50° C. It is preferable that a length of a flame blown from the firing nozzle be 5 mm to 100 mm, and it is further preferable that the length be in the range of 10 mm to 50 mm. In addition, with respect to a distance between a film and the firing treatment nozzle, it is preferable that the film be treatmented at a position from a end of a flame to ½ of the flame length, and in particular, to ⅓ of the flame length.

With respect to the hydrophilization treatment, a water solution at 10° C. to 50° C. containing at a rate of 1 mol/L to 15 mol/L of hydrazine hydrate and 0.5 mol/L to 5 mol/L of alkali metal hydroxide is used for the hydrophilization treatment. Available alkali metals include sodium, potassium, lithium or the like. The reason why a water solution containing hydrazine hydrate and an alkali metal hydroxide is used is that the thermoplastic polyimide resin surface is hydrophilized by the cutting of imide bond due to hydrazine hydrate and by hydrolysis due to alkali metal hydroxide, and facilitating adsorption of a catalytic nucleus for electroless plating. In the case where the concentration of hydrazine hydrate is smaller than 1 mol/L, there is tendency that the cutting of imide bond is not sufficiently carried out. In addition, in the case where the concentration of hydrazine hydrate is 15 mol/L, there is tendency that the adhesion strength between an electrolessly plated layer and a polyimide resin film is lowered. Therefore, it is proper that the concentration of hydrazine hydrate is in the range of 1 mol/L to 15 mol/L. In addition, with respect to the alkali metal hydroxide, in the case where the concentration of the alkali metal hydroxide is smaller than 0.5 mol/L, there is tendency that hydrolysis becomes insufficient, and in the case where the concentration is greater than 5 mol/L, there is tendency that adhesion strength is lowered. Therefore, it is proper that the concentration of the alkali metal hydroxide is in the range of 0.5 mol/L to 5 mol/L. The treating time required for hydrophilization varies depending on a condition or the like, and is generally about 30 seconds to 5 minutes, although it cannot be specified.

In general, after these treatmentes, when the film is brought into contact with air, a modified surface is deactivated, and the treating effect may be significantly decreased. Thus, it is preferable that these treatmentes be carried out in vacuum and sputtering continuously be carried out in vacuum.

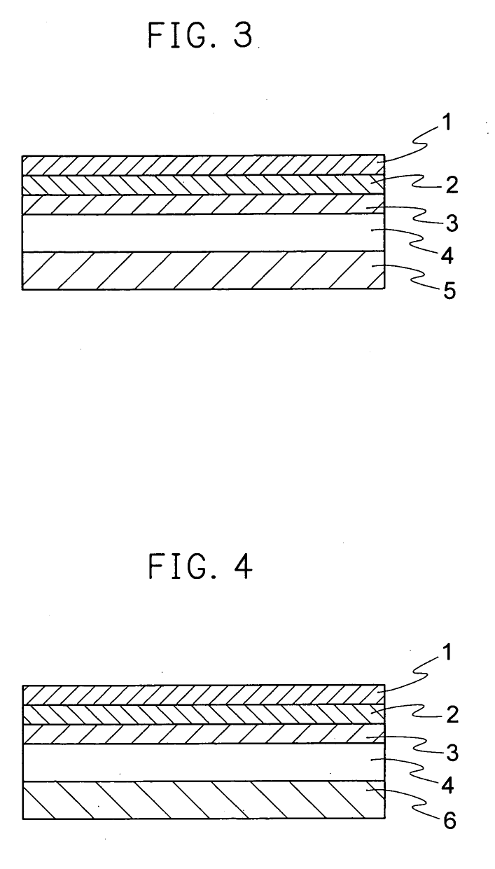

The laminate according to the present invention, as shown in FIG. 3, may have a copper foil layer 5 on a surface of a non-thermoplastic polyimide film 4. The copper foil layer 5 may be formed in accordance with a wet type plating method; may be formed by directly adhering the copper foil having irregularities formed thereon; or may be formed by adhering a copper foil via a proper adhesive. As a method for laminating the polyimide film 4 and the copper oil via the adhesive, a publicly known method such as thermal laminate or thermal pressing can be used.

In addition, the laminate according to the present invention, as shown in FIG. 4, may have an adhesive layer 6 on a surface of the non-thermoplastic polyimide film 4. The adhesive layer is formed by a general adhesive resin. A publicly known technique can be applied to a resin as long as it has proper resin flowability and can achieve strong adhesion property. The resins for use in this adhesive layer can be classified into two types, i.e., an adhesive having thermal fusion property using a thermoplastic resin and a curing type adhesive utilizing a curing reaction of a thermosetting resin. In this way, a thermoplastic polyimide layer 3 is formed on one face of the non-thermoplastic polyimide film 4, and a resin layer having adhesion property of type which is the same to or different from the thermoplastic polyimide resin is formed on the other face, thereby providing a construction having an adhesive layer suitable to laminate with an inner layer substrate. Thus, this construction is suitably used for preparing a build-up multi-layered printed circuit board. The adhesive layer may not be formed on the non-thermoplastic polyimide film, and may be formed on a face which does not have a metal layer of the thermoplastic polyimide layer.

The thermoplastic resins can include: a polyimide resin; a polyamide imide resin; a polyether imide resin; a polyamide resin; a polyester resin; a polycarbonate resin; a polyketone resin; a polysulfone resin; a polyphenylene ether resin; a polyolefin resin; a polyphenylene sulfide resin; a fluorocarbon resin; a polyarylate resin; and a liquid crystal polymer resin or the like. A combination of one or more kinds of these resins can be used as an adhesive layer of the laminate according to the present invention. Among them, it is preferable to use a thermoplastic polyimide resin from the viewpoint of excellent thermal resistance and electrical reliability or the like. An acid dianhydride component of the polyimide resin can be used by combining publicly known one or more kinds. In order to develop particularly excellent thermal fusion property, it is preferable to use, as an acid dianhydride component, an ethylene bis(trimellitic acid monoester acid anhydride, 2,2-bis(4-hydroxyphenyl)propanedibenzoate-3,3′,4,4′-tetracarboxylic acid dianhydride; 1,2-ethylene bis(trimellitic acid monoester anhydride), 4,4′-hexafluoroisopropylidenediphthalate anhydride; 2,3,3′,4′-biphenyltetracarboxylic acid dianhydride; 4,4′-oxydiphthalate anhydride; 3,3′,4,4′-benzophenontetracarboxylic acid dianhydride; or 4,4′-(4,4′-isopropylidenephenoxy)bis(anhydrous phthalic acid).

In addition, a combination of publicly known one or more diamine components can be used. Among them, it is preferable to use 1,3-bis(3-aminophenoxy)benzene; 3,3′-dihydroxybenzidine; or bis(4-(3-aminophenoxy)phenyl)sulfone and the like independently or to be mixed at an arbitrary rate.

The thermosetting resin can include: bis maleimide resin; a bis allylnadiimide resin; a phenol resin; a cyanate resin; an epoxy resin; an acrylic resin; a methacrylic resin; a triazine resin; hydrosilyl cured resin; an allyl cured resin; and an unsaturated polyester resin or the like. These resins can be used alone or in proper combination. In addition to the thermosetting resin, a side chain reactive group type thermosetting polymer having a reactive group such as an epoxy group, an allyl group, a vinyl group, an alkoxy silyl group, a hydrosilyl group, or a hydroxide group and the like on a side chain or terminal of a polymeric chain can be used as a thermosetting component. For the purpose of controlling flowability of adhesive during heating adhesion, it is possible to mix the thermosetting resin with the thermoplastic resin. At this time, it is desirable to add 1 to 10000 parts by weight of a thermosetting resin, preferably 5 to 2000 parts by weight based on 100 parts by weight of a thermoplastic resin. If the thermosetting resin is too large in amount, there is a danger that an adhesive layer becomes brittle. On the other hand, if it is too small in amount, there is a danger that the flowability of adhesive is lowered or adhesion property is lowered.

In addition, from the viewpoint of the adhesion property, treatment property, heat resistance, flexibility, dimensional stability, low dielectric characteristics and price, it is possible to preferably use a polyimide resin, an epoxy resin, a cyanate ester resin, or a blend thereof.

The printed circuit board according to the present invention is prepared as follows.

With respect to the method for preparing a circuit board using a metal layer/a polyimide film laminate, an electrolessly plated copper is applied onto a metal layer surface in a first method for preparing a printed circuit board. This electroless plating can be carried out in accordance with a chemical plating using a palladium catalyst, or alternatively, a direct plating using palladium or carbon and the like. Although this step of electroless plating is carried out in order to apply a treatment resistance and/or in order to cover a pin hole defect portion, this step may be occasionally eliminated. Further, a resist film is formed on the electrolessly plated copper, and a resist film of a portion at which a circuit is to be formed is removed in accordance with exposure and etching. Next, an electrolessly plated film or a portion at which the metal layer according to the present invention is exposed is used as a feeding electrode, and a circuit is formed in accordance with a pattern plating method using an electrolytic copper. Then, the resist portion is removed, and an electrolessly plated layer of an unnecessary portion and a metal layer formed in a physical method are removed by means of etching, thereby forming a circuit. This method is provided as a method called a semi-additive process.

A second method for preparing preparing a printed circuit board will be described as follows. First, as in the first preparing method, an electrolessly plated copper layer is formed on a surface of a metal layer. As in the first preparing method, the electroless plating step can be eliminated. Next, an electroplated of copper is applied, and a resist film is formed on a surface of the electroplated copper layer. Then, a resist film of a portion at which a circuit is not formed is removed in accordance with an exposure step and developing step. Next, an unnecessary metal layer is removed by means of etching, and a circuit is formed. This method is provided as a method called a subtractive process.

With respect to a method for preparing a circuit board using a laminate comprising a metal layer/a polyimide film/metal layer, in the first method for preparing a printed circuit board, first, a via hole penetrating a laminate is formed. Then, the step of de-smearing is carried out to remove a smear which consists essentially of a polyimide decomposed substance produced on the surface of the metal layer and inside of the via hole and a carbide produced by a heat. Next, an electrolessly plated copper is applied to at least the inside of the via hole. As described above, this electroless plating can be carried out in accordance with chemical plating using a palladium catalyst, or alternatively, direct plating using palladium or carbon. Further, a resist film is formed, and then, a resist film of a portion at which a circuit is to be formed is removed by means of exposure and developing. Next, a portion at which the electrolessly plated layer or the metal layer according to the present invention is exposed is used as a feeding electrode, and pattern plating using electrolytic copper is carried out, thereby forming a circuit. Then, a resist portion is removed, the electrolessly plated layer of the unnecessary portion and the metal layer according to the present invention or the metal layer according to the present invention are(is) removed by means of etching, thereby forming a circuit. This circuit forming method is provided as a method called a semi-additive process.

In the second method for preparing a printed circuit board, first, a via hole penetrating a laminate is formed. Next, as in the first preparing method, an electrolessly plated copper layer is formed at least inside of the via hole after the step of de-smearing. Next, panel plating is applied by an electroplating of copper, and metal layers on both faces are electrically connected by the via hole. Next, a resist film is formed on a surface of an electroplated copper layer, and then, a resist film of a portion at which a circuit is not to be formed is removed by means of exposure and developing. Next, an unnecessary metal layer is formed by means of etching, thereby forming a circuit.

With respect to a method for preparing a printed circuit board using a laminate of a metal layer/a polyimide film layer/a copper foil layer, in a first method for preparing a printed circuit board, first, there is formed a via hole reaching or penetrating a metal copper foil through the metal layer formed in accordance with the physical method and polyimide film layer. Then, the surface of the metal layer and the inside of the via hole are de-smeared. Next, an electroless plating of copper is conducted to at least the inside of the vir hole. Next, a resist film is formed on the electrolessly plated copper and/or on the metal layer according to the present invention, and then, a resist film at a portion at which a circuit is to be formed is removed by means of exposure and developing. Next, a portion at which the electrolessly plated film and/or the metal layer according to the present invention are(is) exposed is used as a feeding electrode; and pattern plating using an electrolytic copper is carried out, thereby forming a circuit. Next, a resist portion is removed, and then, an electrolessly plated layer of an unnecessary portion and the metal layer according to the present invention or the metal layer according to the present invention are(is) removed by means of etching, thereby forming a circuit. On the copper foil layer as well, a circuit is formed in accordance with a publicly known method such as a subtractive method.

In a second method for preparing a printed circuit board, first, there is formed a via hole reaching or penetrating the metal copper foil through the metal layer layer formed in accordance with the physical method and polyimide film. Next, in the same manner as that described above, after de-smearing, an electrolessly plated copper layer is formed at least inside of the via hole. Next, an electroplated copper is formed on the electrolessly plated copper layer and/or the metal layer according to the present invention, thereby fabricating a laminate, having both faces of which are electrically connected by the via hole. Next, a resist film is formed on a surface of the electroplated copper layer, and then, a resist film of a portion at which a circuit is not to be formed is removed by means of exposure and developing. Next, an unnecessary metal layer is removed by means of etching, thereby forming a circuit. On the copper foil layer as well, a circuit is formed in accordance with a publicly known method such as a subtractive method.

With respect to a method of preparing a wring board using a laminate which comprises a metal layer/a polyimide film layer/an adhesive layer, in a first method for preparing a first printed circuit board, first, an adhesive layer of the laminate and a circuit face of a circuit board on which a circuit has been formed are opposed with each other, and lamination is carried out in accordance with a method using heating and/or pressurization. Next, there is formed a via hole reaching the circuit board circuit through the metal layer and the polyimide film layer. Then, the step of removing a smear which consists essentially of the polyimide fused substance, decomposed substance produced on the surface of the metal layer and inside of the via hole, the carbide produced by a heat or the like is carried out. Next, an electrolessly plated copper layer is formed at least inside of the via hole. Then, a resist film is formed, and then, a resist film at a portion at which a circuit is to be formed is removed by means of exposure and developing. Next, an electrolessly plated film and/or a portion at which the metal layer according to the present invention are(is) used as a feeding electrode, and pattern plating using an electrolytic copper is carried out, thereby forming a circuit. Next, a resist portion is removed, and then, an electrolessly plated layer of an unnecessary portion and the metal layer according to the present invention or the metal layer according to the present invention are(is) removed by means of etching, thereby forming a circuit.

In a second method for preparing a printed circuit board, first, an adhesive layer of the laminate and a circuit face of the circuit board on which a circuit has been formed are opposed to each other, and lamination is carried out in accordance with a method using heating and/or pressurization. Next, a via hole penetrating the metal layer and polyimide film layer and reaching the circuit board circuit is formed. Next, in the same manner as that described above, after de-smearing, an electrolessly plated copper is applied at least to the inside of the via hole. Next, an electropanelplating of copper is applied onto the electrolessly plated copper and/or on the metal layer according to the present invention. Next, a resist film is formed on a surface of the electroplated copper layer, and then, a resist film of a portion at which a circuit is not to be formed is removed by means of exposure and developing. Next, an unnecessary metal layer is formed by means of etching, thereby forming a circuit.

In addition, in the above described method, a circuit face of a circuit-formed circuit board may be laminated via an adhesive sheet instead of laminating the adhesive layer of the laminate which consists of the metal layer/polyimide film layer/adhesive layer and the circuit face of the circuit-formed circuit board.

In addition, the present invention includes: preparing a printed circuit board of which metal layers are formed on both faces, or alternatively, a multi-layered printed circuit board on which laminates are further multi-layered, by using the laminate according to the present invention.

In the case where a double-sided printed circuit board is prepared by carrying out a heating treatment or an ion gun treatment for a surface of a thermoplastic polyimide layer, it is preferable to use a laminate on which a thermoplastic polyimide layer is provided on both faces of a non-thermoplastic polyimide film, and a metal layer is formed on both faces by means of sputtering, for example, after the respective surface has been ion-gun treated or while the surface is heated. In addition, in a method for preparing a multi-layered printed circuit board, it is preferable to use a laminate on which thermoplastic polyimide layers are provided on both faces of the non-thermoplastic polyimide film and a metal layer is formed by means of sputtering, for example, after the respective surface has been ion-gun treated or while the surface is heated. A double-sided printed circuit board is prepared by using this laminate, and is multi-layered via a sheet of an adhesive arranged between the layers. Alternatively, it is possible to apply a so called buildup process for preparing a (metal layer/thermoplastic polyimide layer/non-thermoplastic polyimide film/adhesive layer) laminate on which a thermoplastic polyimide layer/a metal layer is formed on one face of a non-thermoplastic polyimide film; an adhesive layer is provided on a face on which no metal layer is formed; and circuit layers are laminated.

In addition, a printed circuit board are prepared as follows by using a thermoplastic polyimide resin film surface-treated by combining one or more treatments selected from among a plasma treatment; a corona treatment; a coupling agent treatment; a permanganate treatment; a ultraviolet-ray emitting treatment; an electron beam emitting treatment; a surface treatment by colliding an abrasive at a high speed; a firing treatment; and a hydrophilization treatment.

In a first method for preparing a printed circuit board, first, a metal layer is formed in accordance with a method such as an electroless plating of copper on a thermoplastic polyimide resin surface. Further, a resist film is formed on an electrolessly plated copper, and then, a resist film of a portion at which a circuit is to be formed is removed by means of exposure and etching. Next, the electrolessly plated film or a portion at which the metal layer according to the present invention is exposed are used as a feeding electrode, thereby forming a circuit in accordance with a pattern plating method using an electrolytic copper. Next, a resist portion is removed, and the metal layer formed by electroless plating of an unnecessary portion is removed by means of etching, thereby forming a circuit and preparing a printed circuit board. This method is provided as a method called a semi-additive process. Before carrying out electroless plating, a through hole is dripped as required, and a de-smearing treatment is carried out in accordance with a method using a sulfuric acid, a chromic acid, a permanganate, or plasma and the like. Then, a resin surface and a hole wall are electrolessly plated, thereby make it possible to ensure that the top and bottom of a film are conductive to each other.

In a second method for preparing a printed circuit board, first, in the same manner as that described above, a metal layer is formed by means of electroless plating on a thermoplastic polyimide resin surface on which through hole drilling and de-smearing treatment have been properly carried out as required. Next, electroplating is applied to form a metal layer having thickness of 5 μm or more in general. Then, a resist film is formed on an electroplated layer surface, and a resist film of a portion at which a circuit is not to be formed is removed by means of an exposure and a developing. Next, an unnecessary metal layer is removed by means of etching, thereby forming a circuit and preparing a printed circuit board. This method is called a subtractive process.

In a third method for preparing a printed circuit board, first, a metal layer is formed in accordance with any of a sputtering method, a vacuum vapor deposition method, an ion plating method, and a chemical vapor deposition method, on a thermoplastic polyimide resin surface on which through hole drilling and de-smearing treatment have been properly carried out as required. Then, a circuit is formed by using the semi-additive process or subtractive process, and a printed circuit board is prepared.

In a forth method for preparing a printed circuit board, first, a laminate is laminated on an inner-layered substrate on which an inner-layered circuit has already been formed, so that at least of a thermoplastic polyimide resin serves as an outer-layered side of the board. After via hole or through hole drilling and de-smearing have been properly carried out as required, a metal layer is formed on a thermoplastic polyimide resin surface in accordance with any of an electroless plating method, a sputtering method, a vacuum vapor deposition method, an ion plating method, and a chemical vapor deposition method. Then, a circuit is formed and a multi-layered printed circuit board is prepared by using the semi-additive process or subtractive process.

In a double-sided printed circuit board and a multi-layered printed circuit board, in order to connect layers to each other, it is mandatory to form a through hole or a via hole, to carry out a de-smearing treatment for hole cleaning, and to carry out an electroless plating treatment. However, these printed circuit boards each have sufficient resistance against a de-smearing liquid and an electroless copper plating liquid (in general, strong alkaline property) by using the laminate according to the present invention. In addition, by combining an ion gun treatment or a heating treatment with each other, it is possible to manufacture a good double-sided or multi-layered printed circuit board which have solved a problem that, when a pressure cooker test is carried out, an adhesion force is remarkably lowered.

In addition, with respect to a method for preparing printed circuit board prepared by laminating a laminate having an adhesive layer and a circuit-formed circuit board, followed by forming a metal layer, in a first method for preparing a printed circuit board, first, an adhesive layer of a laminate and a circuit face of a circuit-formed circuit board are opposed to each other, and lamination is carried out in accordance with a method using heating and/or pressurization. Next, a vie hole penetrating the laminate and reaching a circuit of the circuit board is formed. Then, the step of removing a smear which consists essentially of the polyimide fused substance produced on a surface of a metal layer and inside of a via hole, decomposed substance and a carbide produced by a heat is carried out. Next, a conductor layer is formed on a thermoplastic polyimide layer surface in accordance with a physical vapor deposition method, and panel plating is carried out. At this time, panel plating can also be carried out for the inside of the via hole. Next, a resist film is formed, and then, a resist film of a portion at which a circuit is to be formed is removed by means of exposure and developing. Next, a portion at which the conductor layer formed by a physical vapor deposition method is exposed is used as a feeding electrode, and pattern plating by an electrolytic copper is carried out, thereby forming a circuit. Next, a resist portion is removed, and the conductor layer formed by a physical vapor deposition method of an unnecessary portion is removed by means of etching, thereby forming a circuit.

This preparing method is characterized in that panel plating is carried out in accordance with the physical vapor deposition method. In general, the physical vapor deposition method is a dry process that is carried out in vacuum. In addition, dry de-smearing using a plasma treatment is also carried out in vacuum. Thus, this method is particularly preferable because it can be carried out in the same chamber together with a physical vapor deposition that follows. In addition, an atmospheric plasma treatment carried out under an atmospheric pressure is also preferable. These vacuum plasma treatment and atmospheric plasma treatment each are carried out as a de-smearing treatment. In the case where these treatments are compared with a permanganate de-smearing treatment, there is tendency that the permanganate de-smearing treatment becomes lower in adhesion strength between a conductor layer formed by a physical vapor deposition tretment and a thermoplastic polyimide layer. Therefore, the vacuum plasma tretment and atmospheric pressure plasma tretment are preferably carried out. In addition, these de-smearing treatments are carried out in order to remove the smear produced by laser drilling. Therefore, in the case where no or little smear occurs due to optimization of a laser condition and due to improvement of performance, it is possible to eliminate the step of de-smearing.

In a second method for preparing a printed circuit board, first, an adhesive layer of a laminate and a circuit face of the circuit-formed circuit board are opposed to each other, and lamination is carried out in accordance with a method using heating and/or pressurization. A via hole penetrating the laminate and reaching a circuit of a circuit-formed circuit board. Next, in the same manner as that described above, after de-smearing, panel plating is carried out in accordance with a physical vapor deposition method. Next, panel plating in accordance with electroplating is carried out on the panel plated layer formed by a physical vapor deposition method. Next, a resist film is formed on a surface of an electroplated layer, and a resist film of a portion at which a circuit is not to be formed is removed by means of exposure and developing. Further, an unnecessary metal layer is removed by means of etching, thereby forming a circuit.

In addition, as described above, this preparing method is characterized in that panel plating is carried out in accordance with a physical vapor deposition method instead of a wet type electroless plating which has been generally used conventionally. Thus, the preparing method is characterized in that there is no problem with environmental contamination which has been problematic in the wet type plating.

In a method for preparing a printed circuit board according to the present invention, it is possible to properly select a process and a process condition according to the specification of a desired printed circuit board. In addition, it is possible to combine another publicly known technique.

That is, a via hole can be formed in accordance with a drilling method using a publicly known carbonate gas laser, a UV-YAG laser, excimer laser, punching, and drilling or the like. In the case where a small via hold is formed, the drilling method using laser is preferably used. Here, the largest problem is a de-smearing step of via hole. In general, in this de-smearing step, a alkaline de-smearing treatment using a permanganate is carried out. At this time, if a treating condition is strengthened in order to obtain a sufficient de-smearing effect, a polyimide resin which is essentially weak in alkali resistance is excessively damaged. Thus, in particular, there occurs a problem that a fatal effect is imparted to a thin metal conductor layer formed in accordance with a method such as sputtering or ion plating, and a crack and a pin hole are generated on the conductor layer under a strong oxidizing force of a de-smearing liquid of the permanganate, or releasing occurs.

However, in the case where a metal layer is formed on a thermoplastic polyimide layer as in a laminate of the present invention, even if a de-smearing is carried out using a general permanganate, no crack, pin hole, and releasing occur with the metal layer. This would be because the thermoplastic polyimide layer is more excellent in alkali chemical resistance than non-thermoplastic polyimide, and thus, is hardly etched; and the thermoplastic polyimide layer is softer than the non-thermoplastic polyimide layer, and thus, metal particles easily cut into the thermoplastic polyimide layer, thereby, rigid adhesion property between the metal particles and the thermoplastic polyimide layer is achieved. That is, in the de-smearing step of the preparing method of the present invention, it is possible to apply a wet process using a permanganate or an organic alkali solution and the like and a dry process utilizing a plasma treament. Therefore, by using the laminate of the present invention, it is possible to reliably carry out a de-smearing treatment of a via hole punched on a printed circuit board in response to a request for high density and a low dielectric rate. In addition, it becomes possible to manufacture a printed circuit board on which no failure such as a pattern release in a printed circuit board preparing step that follows. Further, the metal layer according to the present invention has strong durability in an electroless plating process which includes a catalyst applying step, an activation step, and a chemical plating step that follow the step of de-smearing. Even if an electrolessly plated copper film is formed on its surface, its adhesion force is not lowered.

In addition, in the case where electroless plating is carried out, it is necessary to plate at least the inside of a via hole. However, whether or not to form an electrolessly plated copper on the metal layer surface according to the present invention and copper foil layer surface is determined by properly selecting an engineering technique according to the specification of a desired printed circuit board. In addition, as types of electroless plating, it is possible to apply chemical plating utilizing a catalytic action of a precious metal such as palladium and direct plating using palladium, carbon, an organic manganese conductive film or a conductive polymer. In addition, as a resist, it is possible to use a liquid resist or a dry film resist and the like. In particular, a dry film resist having excellent handling property is preferred. In addition, in the case where a circuit is formed in accordance with a semi-additive process, in etching carried out to remove a feeding layer, it is possible to use sulfuric acid/hydrogen peroxide, per sulfuric acid ammonium/sulfuric acid etchants, or alternatively, etchants capable of selectively etching an element for use in a metal layer of a variety of laminates of the present invention, i.e., nickel, chrome, gold, and titanium or the like.

As has been described above, by using the laminate of the present invention, the preparing step such as the de-smearing step and, if necessary, the electroless plating step can be applied, making it possible to form a high density circuit such that a line/space is at most 20 μm/20 μm and making it possible to provide a printed circuit board having excellent adhesion property and high adhesion reliability in a severe environment such as a high temperature and/or a high humidity.

Hereinafter, advantageous effect of the present invention will be specifically described by way of examples. The present invention is not limited to the following Examples, and various modifications, corrections, and improvements can occur without departing from the spirit of the invention. In Examples, fabrication of a variety of polyimide films; and fabrication of a metal layer, measurement, and evaluation were carried out in accordance with the following methods.

### Embodiment 1

(Method A of Preparing Non-Thermoplastic Polyimide Film)

A transfer agent consisting of 17 g of anhydrous acetic acid and 2 g of isoquinoline was mixed in 90 g of N,N-dimethylformaldehyde amide (hereinafter, referred to as DMF) solution of 17% by weight of a polyamic acid obtained by reaction of pyromellitic acid dianhydride/4,4′-diaminodiphenylether/p-phenylenediamine at a rate of 4/3/1 in molar ratio. After stirring and de-foaming due to centrifugal separation, flow casting and coating were carried out on an aluminum foil in thickness of 700 μm. From stirring to de-foaming was carried out while being cooled to 0° C. A laminate of this aluminum foil and a polyamic acid solution was heated at 110° C. for 4 minutes, and a gel film having self support property was obtained. The remnant volatile content of this gel film was 30% by weight, and an imidization rate was 90%. This gel film was released from an aluminum foil, and was fixed to a frame. This gel film was heated at 300° C., 400° C., and 500° C. for each 1 minute, and a polyimide film having thickness of 25 μm was prepared.

(Method B of Preparing Non-Thermoplastic Polyimide Film)

A polyimide film was prepared in accordance with a method similar to the preparing method A except that pyromellitic acid dianhydride/4,4′-diaminediphenylether was reacted at a rate of 1/1 in molar ratio.

(Method C of Preparing Non-Thermoplastic Polyimide Film)

Using 17% by weight of N,N-dimethyl acetoamide (DMAc) solution of a polyamic acid obtained by reaction of 3,3′,4,4′-biphenyltetracarbonic acid dianhydride/p-phenylene bis (trimellitic acid monoester acid anhydride)/p-phenylenediamine/4,4′-diaminodiphenyl ether at a rate of 4/5/7/2 in molar ratio, a flow casting and coating were carried out on an aluminum foil in thickness of 700 μm without mixing a transfer agent therein. A laminate of this aluminum foil and a polyamic acid solution was heated at 110° C. for 10 minutes, and a gel film having self support property was obtained. The residual volatile content of this gel film was 30% by weight, and the imidization rate was 50%. By using this gel film, a polyimide film was prepared in a method similar to preraring method A.

(Method X of Preparing Thermoplastic Polyimide Precursor)

While 1,2-bis[2-(4-aminophenoxy)ethoxy]ethane (hereinafter, referred to as DA3EG) and 2,2-bis[4-(4-aminophenoxy)phenyl]propane (hereinafter, referred to as BAPP) were dissolved and stirring in DMF at a molar ratio of 3:7, 3,3′,4,4′-ethyleneglycoldibenzoatetetracarboxylic acid dianhydride (hereinafter, referred to as TMEG) and 3,3′,4,4′-benzophenonetetracarboxylic acid dianhydride (hereinafter, referred to as BTDA) was added at a molar ratio of 5:1; stirring was carried out for about 1 hour; and a polyamic acid solution having a solid component concentration of 20% by weight was obtained.

(Method Y of Preparing Thermoplastic Polyimide Precursor)

While uniformly dissolving BAPP in DMF and stirring it, 3,3′,4,4′-biphenyltetracarboxylic acid dianhydride and ethylene bis (trimellitic acid monoester acid anhydride) was added at a molar ratio of 4:1 and so that the acid dianhydride and diamine are equal to each other in mol, stirring was carried out for about 1 hour, and a DMF solution of a polyamic acid having a solid component concentration of 20% by weight was obtained.

(Preparing Laminated Polyimide Film)

The non-thermoplastic polyimide film prepared in accordance with preparing method A, B, or C was used as a core film, and the DMF solution of the polyamic acid which is a precursor of the thermoplastic polyimide prepared by preparing method X or Y was coated by using a gravure coater.

After coating, imidization was carried out by drying solvent at 120° C. for 4 minutes, and heating at a final heating temperature of 390° C., and a laminated polyimide film consisting of the non-thermoplastic polyimide film and the thermoplastic polyimide layer was prepared. In addition, a film having different thickness of the thermoplastic polyimide layer was obtained by changing a coating quantity. In table, these films, for example, in the case where non-thermoplastic polyimide films were prepared in method A and double faces are a thermoplastic polyimide layer prepared in method X, it is defined as X/A/X, and in the case where one face is a thermoplastic polyimide layer and the other face is a copper foil, it is defined as X/A/Cu.

(Forming Metal Layer in Accordance with Sputtering Method)

Using a sputtering device NSP-6 available from Showa Vacuum Co., Ltd, a metal layer was formed on a polyimide film in accordance with the following method. A polymeric film was set to a jig, and a vacuum chamber was closed. While a substrate (polymeric film) was revolved and rotated on its axis, heating was carried out by means of a lamp heater, and vacuum drawing was carried out up to 6×10⁻⁴ Pa or less. Then, argon gas was introduced, and was set at 0.35 Pa. Then, nickel and copper was sputtered by means of DC sputtering. DC powers were 200 W both. A filming speed was 7 nm per minute in nickel and 11 nm per minute in copper, and the film thickness was controlled by adjusting a filming time.

(Praparing Adhesive Layer)

Under a nitrogen atmosphere, 1 equivalent bis {4-(3-aminophenoxy)phenyl}sulfone (hereinafter, referred to as BAPS-M) was dissolved in N,N-dimethyl formamide (hereinafter, referred to as DMF). While cooling a solution and stirring it, a polyamic acid polymer solution having a solid component concentration of 30% by weight was obtained by dissolving and polymerizing 1 equivalent 4,4′-(4,4′-isopropylidenediphenoxy) bis (anhydrous phthalic acid) (hereinafter, referred to as BPADA). This polyamic acid solution was heated at 200° C. for 180 minutes under a reduced pressure of 665 Pa, and a solid thermoplastic polyimide resin was obtained. The above obtained polyimide resin and novolak type epoxy resin (Epicoat 1032H60: available from Yuka Shell Co., Ltd.) and 4,4′-diaminophenyl sulfone (hereinafter, referred to as 4,4′-DDS) were mixed so that a weight ratio is 70/30/9, and was dissolved in dioxolane so that a solid component concentration is 20% by weight, and an adhesive solution was obtained. The obtained adhesive solution was coated on a polyimide film face of a laminate after the metal layer was formed so that the thickness after dried is 12.5 μm; an adhesive layer was formed by drying at 170° C. for 2 minutes, and a laminate was obtained.

(Laminating Step)

An inner layered circuit board was prepared from 12-μm-thick copper foil-clad glass epoxy laminated board. By means of a vacuum press, the laminate was laminated and cured on the inner layer circuit board at a temperature of 200° C., at a hot-plate pressure of 3 MPa, for a pressing time of 2 hours under a vacuum condition of 1 KPa.

(Measuring Adhesion Strength)

An adhesion strength was measured at a pattern width of 3 mm, a release angle of 90 degree, and a release speed of 50 mm per minute in accordance with an IPC-TM-650-method. 2. 4, 9.

(Pressure Cooker Test)

Testing was carried out under a condition of 121° C. 100% RH for 96 hours.

(Evaluation of De-Smear Resistance)

By using an UV laser, in the case of a laminate having a metal layer on both faces, a through hole was formed; and in the case where one face is a copper foil, a non-through hole penetrating a metal layer and a polyimide film layer and reaching a copper foil face was formed. Next, a punched sample was immersed at 70° C. for 10 minutes in a de-smear solution of 50 g/L of potassium permanganate and 40 g/L of sodium hydroxide. After water wash, When it was observed by a microscope whether or not the smear around a hole or the smear on a surface of a hole bottom copper foil in the case of a non-through hole was removed, the smears were completely removed in either case. Therefore, it was observed whether or not any damage is subjected to a metal layer, a polyimide film layer, and a hole wall face, in particular, whether or not a release or floating of a metal layer occurs. 100 holes were formed. A case in which no damage was observed in 100 holes were evaluated as ⊚; a case in which any damage was observed in 1 to 3 holes was evaluated as ◯; a case in which clear damages were within 10 holes was evaluated as Δ; and a case in which 10 or more holes were evaluated as X.

(Measuring Thermal Expansion Coefficient)

A thermal expansion efficient of a thermoplastic polyimide/non-thermoplastic polyimide laminate was measured twice at a temperature rise speed of 20° C.; at a nitrogen flow rate of 50 ml per minute; at a width of 3 mm and at a length of 10 mm in sample shape; at a load of 3 g; at room temperature to 300° C. by using TMA 120C available from Seiko Instrument Co., Ltd, and an average linear expansion coefficient at 100° C. to 200° C. in second time was defined as a thermal expansion coefficient of that laminate.

### EXAMPLES 1 TO 6

On one face of a non-thermoplastic polyimide film having thickness of 25 μm prepared in accordance with preparing method A, B, or C, a polyimide film was formed in accordance with for coating a polyamic acid solution prepared by preparing method X or Y. The thickness of a thermoplastic polyimide layer was 3 μm.

Next, nickel was sputtered for 1 minute on the thermoplastic polyimide layer, and a nickel film having thickness of 6 nm was formed. Copper was continuously sputtered for 9 minutes, a copper film having thickness of 100 nm was formed, and a laminate comprised metal layer/a polyimide film layer was obtained. On the obtained sputtered film, a copper layer having thickness of 18 μm was formed in accordance with an electroplating method. An adhesion strength of this laminate at a normal temperature, an adhesion strength after pressure cooker test, and a de-smear resistance were measured. The measurement result is shown in Table 2.

TABLE 2

| | | | | | Adhesion |
|---|---|---|---|---|---|
| | Polyimide | | | | strength |
| | preparing | | | Peel | after TCT |
| | method and | Constitution of | De-smear | strength | test |
| Ex. | constitution | metal layer | resistance | (N/cm) | (N/cm) |
| 1 | X/A/ | Ni/Cu | ⊚ | 12 | 8 |
| 2 | X/B | Same as above | ⊚ | 11 | 7 |
| 3 | X/C/ | Same as above | ⊚ | 11 | 7 |
| 4 | Y/A/ | Same as above | ⊚ | 11 | 7 |
| 5 | Y/B/ | Same as above | ⊚ | 12 | 7 |
| 6 | Y/C/ | Same as above | ⊚ | 12 | 7 |

From this result, it was found that the laminate according to the present invention can achieve excellent adhesion property and de-smear resistance process property.

### EXAMPLES 7 TO 14

A sample having formed thereon a thermoplastic polyimide layer having different thickness was produced in accordance with a method of coating a polyamic acid solution prepared by preparing method Y on both faces of a thermoplastic polyimide film having thickness of 25 μm prepared in accordance with preparing method C. On this film, a nickel film having thickness of 6 nm was formed by sputtering nickel for 1 minute. Copper was continuously sputtering for 9 minutes, a copper film having thickness of 100 nm was formed, and a laminate layer consisiting of a metal layer/a polyimide film layer was obtained. By using the thus obtained sputtered film as a feeding layer, a copper layer having thickness of 18 μm was formed in accordance with an electroplating method. An adhesion strength of the obtained laminate at a room temperature; an adhesion strength after pressure cooker test; a de-smear resistance; and a thermal expansion coefficient were measured. The measurement result is shown in Table 3. For the thermal expansion rate, the thermal expansion rate of non-thermoplastic film A was 12 ppm/° C. in the present experimentation. Thus, a case in which the thermal expansion coefficient value after the thermoplastic layer was formed is at most 20 ppm/° C. was evaluated as ⊚; a case in which the value is at most 25 ppm/° C. was evaluated as ◯; a case in which the value is at most 30 ppm/° C. was evaluated as Δ; and a case in which the value is at least 30 ppm/° C. was evaluated as X.

TABLE 3

| | Thickness (μm) | | | Adhesion | Thermal |
|---|---|---|---|---|---|
| | of thermoplastic | | Peel | strength | expansion |
| | polyimide layer Y | De-smear | strength | after PCT | coefficient |
| Ex. | (μm) | resistance | (N/cm) | (N/cm) | (ppm/° C.) |
| 7 | 0.01 | Δ | 7 | 4 | ⊚ |
| 8 | 0.05 | ⊚ | 10 | 5 | ⊚ |
| 9 | 0.1 | ⊚ | 10 | 6 | ⊚ |
| 10 | 1.0 | ⊚ | 10 | 7 | ⊚ |
| 11 | 3.0 | ⊚ | 12 | 8 | ⊚ |
| 12 | 5.0 | ⊚ | 13 | 8 | ◯ |
| 13 | 10 | ⊚ | 13 | 8 | Δ |
| 14 | 20 | ⊚ | 12 | 7 | X |

From this result, it was found that the thickness of the thermoplastic polyimide layer is preferable at most 10 μm to at least 0.01 μm; and that the thickness is more preferable at most 5 μm to at least 0.1 μm.

### EXAMPLES 15 TO 22

A thermoplastic polyimide layer having thickness of 1 μm, 5 μm, or 10 μm was formed in accordance with a method for coating a polyamic acid solution prepared in accordance with preparing method Y on both faces of the non-thermoplastic polyimide film having thickness of 7.5 μm, 12.5 μm, 25 μm, or 50 μm prepared in accordance with preparing method C.

By sputtering nickel on this film for 1 minute, a nickel film having thickness of 6 nm was formed. A copper film having thickness of 100 nm was formed by continuously sputtering copper for 9 minutes, and a laminate consisting of a metal layer/a polyimide film layer was obtained. By using the thus obtained sputtered film as a feeding layer, a copper layer having thickness of 5 μm was formed in accordance with an electroplating method. An adhesion strength of this laminate at a room temperature, an adhesion strength after pressure cooker test, a de-smear resistance, and a thermal expansion coefficient were measured. The measurement result is shown in Table 4. For the thermal expansion rate, the thermal expansion rate of non-thermoplastic film A was 12 ppm/° C. in the present experimentation. Thus, a case in which the thermal expansion coefficient value after the thermoplastic layer was formed is at most 20 ppm/° C. was evaluated as ⊚; a case in which the value is at most 25 ppm/° C. was evaluated as ◯; a case in which the value is at most 30 ppm/° C. was evaluated as Δ; and a case in which the value is at least 30 ppm/° C. was evaluated as X.

TABLE 4

| | Thickness | Thickness | | | | |
|---|---|---|---|---|---|---|
| | of non- | of | | | | |
| | thermo- | thermo- | | | | |
| | plastic | plastic | | | Adhesion | Thermal |
| | polyimide | polyimide | | Peel | strength | expansion |
| | layer C | layer Y | De-smear | strength | after PCT | coefficient |
| Ex. | (μm) | (μm) | resistance | (N/cm) | (N/cm) | (ppm/° C.) |
| 15 | 7.5 | 1 | ⊚ | 11 | 6 | ⊚ |
| 16 | 7.5 | 5 | ⊚ | 12 | 7 | X |
| 17 | 7.5 | 10 | ⊚ | 12 | 7 | X |
| 18 | 12.5 | 5 | ⊚ | 12 | 8 | Δ |
| 19 | 12.5 | 10 | ⊚ | 12 | 8 | X |
| 20 | 25 | 5 | ⊚ | 13 | 8 | ◯ |
| 21 | 25 | 10 | ⊚ | 13 | 8 | Δ |
| 22 | 50 | 10 | ⊚ | 13 | 8 | ◯ |

From this result, in order to utilize physical property (such as thermal expansion coefficient, for example) of a non-thermoplastic polyimide film having excellent property as a printed circuit board, it is necessary that the thickness of a thermoplastic polyimide layer is smaller than a non-thermoplastic polyimide layer. Preferably, it was found that the thickness of each face of the thermoplastic polyimide layer be at most ½ of the thermoplastic polyimide layer. More preferably, it was found that the thickness be at most ⅕ of the above layer.

### COMPARATIVE EXAMPLE 1

On a surface of a non-thermoplastic polyimide film (i.e., film without thermoplastic polyimide layer) prepared in accordance with preparing method A, a metal film was formed by a method similar to that shown in Example 1, and adhesion property and de-smear resistance were measured in accordance with a similar method. As a result, the adhesion strength was 7 N/cm, and however, the adhesion strength after pressure cooker was lowered to be 2 N/cm. In addition, the de-smear resistance was evaluated as X. By making comparison between this result and that of Table 2, it was found that, in the case where a thermoplastic polyimide layer does not exist, predetermined characteristics cannot be obtained, and advantageous effect of a thermoplastic polyimide layer was verified.

### EXAMPLES 23 TO 32

In the same manner as in Example 1, a nickel undercoat layer (first metal layer) and a metal layer (second metal layer) consisting of a copper layer having a variety of thickness was formed, and its adhesion strength was measured. The measurement result is shown in Table 5.

TABLE 5

| | Thickness | Thickness of | | | Adhesion |
|---|---|---|---|---|---|
| | (μm) of | copper layer | | | strength |
| | nickel | (second | | Peel | after PCT |
| | undercoat | metal layer) | De-smear | strength | test |
| Ex. | layer (nm) | (nm) | resistance | (N/cm) | (N/cm) |
| 23 | 0 | 100 | X | 7 | 3 |
| 24 | 2 | 100 | Δ | 11 | 5 |
| 25 | 5 | 100 | ⊚ | 11 | 7 |
| 26 | 10 | 5 | X | 9 | 2 |
| 27 | 10 | 10 | Δ | 10 | 5 |
| 28 | 10 | 100 | ⊚ | 12 | 7 |
| 29 | 10 | 200 | ⊚ | 12 | 7 |
| 30 | 20 | 500 | ⊚ | 12 | 7 |
| 31 | 50 | 100 | ⊚ | 10 | 6 |
| 32 | 100 | 100 | ⊚ | 8 | 4 |

From this result, it was found that the nickel undercoat layer is preferable in thickness of 2 nm or more and that the copper layer is preferable in thickness of 10 nm or more.

### EXAMPLE 33

Anickel undercoat layer having thickness of 5 nm (first metal layer) and a copper metal layer having thickness of 100 nm (second metal layer) were formed on both faces of a polyimide film having a construction of Y/B/Y (wherein Y is 1 μm and B is 25 μm) in accordance with a sputtering method to prepare a laminate. By using this laminate, a circuit was formed in the following manner.

First, after a via hole having an inner diameter of 30 μm and penetrating the laminate was formed by using a UV-YAG laser, de-smearing treatment was carried out by immersing the laminate in a de-smearing solution of 50 g/L of potassium permanganate and 40 g/L of sodium hydroxide at 70° C. for 10 minutes. Next, a plated copper layer was formed on a surface of the metal layer and inside of the via hole in accordance with an electroless plating method. A method for forming an electrolessly plated layer is as follows. First, the laminate was washed by an alkaline cleaner liquid, and then, pre-dipping was carried out by acid for a short time. Further, palladium addition and alkali reduction were carried out in an alkaline solution. Then, electroless plating in alkali was carried out. The plating temperature was equal to room temperature, and the plating time was 10 minutes. In this method, an electrolessly plated copper layer having thickness of 300 nm was formed.

Next, after coating a liquid photosensitive plating resist (THB320P available from Nippon Synthesis Rubber Co., Ltd.), mask exposure was carried out by using a high voltage mercury lamp, and a resist pattern having a line/space of 10 μm/10 μm was formed. Subsequently, electroplating of copper was carried out, and a copper circuit was formed on a surface of a portion at which an electrolessly plated copper film was exposed. Electroplating of copper was carried out by preliminary washing for 30 second in 10% sulfuric acid, and then, plating for 40 minutes in room temperature. The current density was 2 A/dm². The thickness of an electroplated copper film was 10 μm. Next, a plating resist was peeled by using an alkali type peeling liquid; a sputtered nickel layer was removed by selective etching liquid of nickel (etching liquid, NH-1862 available from Meck Co., Ltd.); and a printed circuit board was obtained.

The obtained printed circuit board has a line/space as specified at a designed value, and no undercut was observed. Further, although Auger electron spectroscopy of a peeled portion of the feeding layer and measurement of the presence or absence of the residual metal by EPMA were carried out, the presence of the residual metal was not observed. In addition, a circuit pattern was strongly adhered by strength of 11 N/cm.

### EXAMPLE 34

First, a laminate having a construction of X/A/Cu (wherein X is 1 μm, A is 25 μm, and a copper foil is 15 μm) was prepared; and a laminate having formed a nickel undercoat layer having thickness of 5 nm (first metal layer) and a copper metal layer having thickness of 100 nm (second metal layer) on an X layer surface was prepared in accordance with a sputtering method. By using this laminate, a circuit was formed in the following manner.

First, a polymeric film serving as a protective film was adhered on a metal layer surface formed in accordance with a sputtering method. Next, a dry film resist (Asahikasei dry resist AQ) was adhered on a copper foil; exposure and developing were carried out; and a circuit having a line/space of 30 μm/30 μm was formed in accordance with a general subtractive process. The used etching liquid was a ferric chloride water solution. Next, the protective film was removed, and a microcircuit having a line/space of 10 μm/10 μm was formed on a sputtered metal layer face in the same manner in Example 33. There is a difference in that, in Example 33, a via hole was provided as a through hole, whereas in this Example, there was provided a hole penetrating a sputtered metal layer and a polyimide film layer, the hole reaching a circuit back face formed by using a copper foil.

The obtained printed circuit board has a line/space as specified at a designed value, and no undercut was observed. Further, although Auger electron spectroscopy of a peeled portion of feeding layer and measurement of the presence or absence of the residual metal by EPMA were carried out, the presence of the residual metal layer was not observed. In addition, a circuit pattern was strongly adhered at strength of 11 N/cm.

### EXAMPLE 35

A nickel undercoat layer having thickness of 5 nm (first metal layer) and a copper metal layer having thickness of 100 nm (second metal layer) were formed in accordance with a sputtering technique on both faces of a polyimide film having a construction of X/A/X (wherein X is 1 μm and A is 25 μm). By using this laminate, a circuit is formed in accordance with the following manner.

First, a via hole having an inner diameter of 30 μm penetrating a laminate was formed by using a UV-YAG laser. After a de-smearing treatment was carried out, a plated copper layer was formed on the metal layer surface and inside of the via hole in accordance with an electroless plating method. A method for forming an electrolessly plated layer is as follows. First, the laminate was washed by an alkaline cleaner liquid, and then, pre-dipping was carried out by acid for a short time. Further, palladium addition and alkali reduction were carried out in an alkaline solution. Next, chemical copper plating in an alkali was carried out. The plating temperature was equal to room temperature, and the plating time was 10 minutes. An electrolessly plated copper layer having thickness of 300 nm was formed in this method. Then, a plated copper layer having thickness of 10 μm was formed by carrying out electroplating of copper. Electroplating of copper was carried out by preliminary washing for 30 seconds in 10% sulfuric acid, and then, plating for 40 minutes at room temperature. The current density was 2 A/dm². The thickness of an electrolytic copper film was 10 μm.

Next, after coating a liquid photosensitive plating resist (THB320P available from Nippon Synthesis Rubber Co., Ltd.), mask exposure was carried out by using a high voltage mercury lamp, and a resist pattern having a line/space of 10 μm/10 μm was formed. By using the thus formed pattern, a circuit was formed in accordance with a general subtractive process (agent: Ferric chloride). Next, a sputtered nickel layer was removed by a selective etching liquid of nickel (etching liquid, NH-1862 available from Meck Co., Ltd.), and further, a plating resist was peeled by using an alkali type peeling liquid, and a printed circuit board was prepared.

The obtained printed circuit board had a line/space as specified at a designed value, and no undercut was observed. Further, although Auger electron spectroscopy of a peeled portion of feeding layer and measurement of the presence or absence of the remnant metal by EPMA were carried out, the presence of the remnant metal was not observed. In addition, a circuit pattern was strongly adhered at strength of 11 N/cm.

### EXAMPLE 36

A polyimide film was prepared in accordance with a method for applying a polyamic acid solution prepared in preparing method X on one face of a non-thermoplastic polyimide film having thickness of 25 μm prepared in preparing method A. The thickness of a thermoplastic polyimide film was 3 μm. A nickel film having thickness of 6 nm was formed by sputtering nickel for this film for 1 minute. A copper film having thickness of 100 nm was formed by continuously sputtering copper for 9 minutes, and a laminate consisting of a metal layer/a polyimide film layer was obtained.

Next, an adhesive layer was applied, and a laminate consisting of a metal layer/a polyimide film layer/an adhesive layer was obtained. Further, this laminate is laminated and cured on an inner layer circuit board prepared from the copper foil-clad glass epoxy laminated board, and a build-up substrate was obtained. A method for forming the thickness of the adhesive layer and the lamination method are as described previously.

Next, by using a UV-YAG laser, after a via hole having an inner diameter of 30 μm which reaches an inner layer circuit has been formed, a de-smearing treatment was carried out by immersing the substrate at 70° C. for 10 minutes in a de-smearing solution of 50 g/L of potassium permanganate and 40 g/L of sodium hydroxide. Next, a plated copper layer was formed on the metal layer surface and inside of the via hole in electroless plating method. A method for forming an electrolessly plated layer is as follows. First, the laminate was washed by an alkaline cleaner liquid, and then, pre-dipping was carried out by acid for a short time. Further, palladium addition and alkali reduction were carried out in an alkaline solution. Next, electroless copper plating in an alkali was carried out. The plating temperature was equal to room temperature, and the plating time was 10 minutes. An electrolessly plated copper layer having thickness of 300 nm was formed in this method.

Next, after coating a liquid photosensitive plating resist (THB320P available from Nippon Synthesis Rubber Co., Ltd.), mask exposure was carried out by using a high voltage mercury lamp, and a resist pattern having a line/space of 10 μm/10 μm was formed. Then, electroplating of copper was carried out, and a copper circuit was formed on a surface of a portion at which an electrolessly plated copper film is exposed. Electroplating of copper was carried out by preliminary washing for 30 seconds in 10% sulfuric acid, and then, plating for 40 minutes at a room temperature. The current density was 2 A/dm². The thickness of an electrolytic copper film was 10 μm. Next, a plating resist was peeled by using an alkali type peeling liquid; a sputtered nickel layer was removed by using a selective etching liquid of nickel (etching liquid, NH-1862 available from Meck Co., Ltd.); and a printed circuit board was obtained.

The obtained printed circuit board has a line/space as specified at a designed value, and no undercut was observed. Further, although Auger electron spectroscopy of a peeled portion of feeding layer and measurement of the presence or absence of the remnant metal by EPMA were carried out, the presence of the remnant metal was not observed. In addition, a circuit pattern was strongly adhered at strength of 13 N/cm. A de-smearing process resistance property was good.

### EXAMPLE 37

In the same menner as that shown in Example 36, a laminate consisted of a sputtered metal layer/Y/C/an adhesive layer was formed; this laminate was laminated and cured on an inner layer circuit board prepared from the copper foil-clad glass epoxy laminated board, and a build-up substrate was obtained.

Next, by using a UV-YAG laser, after a via hole having an inside diameter of 30 μm which reaches an inner layer circuit has been formed, a de-smearing treatment was carried out by immersing the substrate at 70° C. for 10 minutes in a de-smearing solution of 50 g/L of potassium permanganateand 40 g/L of sodium hydroxide. Next, a plated copper layer was formed on the metal layer surface and inside of the via hole in an electroless plating method. A method for forming an electrolessly plated layer was as follows. First, the laminate was washed by an alkaline cleaner liquid, and then, pre-dipping was carried out by acid for a short time. Further, palladium addition and alkali reduction were carried out in an alkaline solution. Next, chemical copper plating in an alkali was carried out. The plating temperature was equal to room temperature, and the plating time was 10 minutes. An electrolessly plated layer having thickness of 300 nm was formed in this method.

Next, after coating a liquid photosensitive plating resist (THB320P available from Nippon Synthesis Rubber Co., Ltd.), mask exposure was carried out by using a high voltage mercury lamp, and a resist pattern having a line/space of 10 μm/10 μm was formed. Then, electroplating of copper was carried out, and a copper circuit was formed on a surface of a portion at which an electrolessly plated copper film is exposed. Electroplating of copper was carried out by preliminary washing for 30 seconds in 10% sulfuric acid, and then, plating for 40 minutes at a room temperature. The current density was 2 A/dm². The thickness of an electrolytic copper film was 10 μm. Next, a plating resist was peeled by using an alkali type peeling liquid; a sputtered nickel layer was removed by using a selective etching liquid of nickel (etching liquid, NH-1862 available from Meck Co., Ltd.); and a printed circuit board was obtained.

The obtained printed circuit board has a line/space as specified at a designed value, and no undercut was observed. Further, although Auger electron spectroscopy of a peeled portion of feeding layer and measurement of the presence or absence of the remnant metal by EPMA were carried out, the presence of the remnant metal was not observed. In addition, a circuit pattern was strongly adhered at strength of 13 N/cm. A de-smearing process resistance property was good.

### Embodiment 2 (Surface Treatment)

### EXAMPLE 38

(Preparing Non-Thermoplastic Polyimide Film)

A transfer agent consisting of 17 g of anhydrous acetic acid and 2 g of isoquinoline was mixed in 90 g of N,N-dimethylacetoamide solution of 17% by weight of a polyamic acid obtained by reaction of pyromellitic acid dianhydride/p-phenylenebis(trimellitic acid monoester acid anhydride)/p-phenylenediamine/4,4′-diaminodiphenylether at a rate of 1/1/1/1 in molar ratio. Next, the mixture is stirred and de-foamed due to centrifugal separation, and then, a flow casting and coating were carried out in thickness of 300 μm on an aluminum foil. From stirring to de-foaming was carried out while cooling to 0° C. A laminate of this aluminum foil and polyamic acid solution was heated at 110° C. for 4 minutes, and a gel film having self-support property was obtained. The remnant volatile content of this gel film was 30% by weight, and an imidization rate was 90%. This gel film was peeled from the aluminum foil, and then, was fixed to a frame. This gel film was heated at 300° C., 400° C., and 500° C. for 1 minute, respectinely. Then, a non-thermoplastic polyimide film having thickness of 25 μm was prepared.

(Method for Preparing Thermoplastic Polyimide Precursor)

As a diamine component, 2,2′-bis[4-(4-aminophenoxy) phenyl]propane was uniformly dissolved in N,N-dimethyl formamide. While stirring, addition was carried out so that 3,3′, 4,4′-biphenyltetracarboxylic acid dianhydride and ethylene bis (trimellitic acid monoester acid anhydride) as an acid anhydride component are 4:1 in molar ratio and an acid anhydride component and a diamine component are equal to each other in mol. Stirring was carried out for about 1 hour, and a N,N-dimethylformamide solution of 20% by weight in solid component concentration which is a precursor of thermoplastic polyimide was obtained.

(Preparing Proparing Laminated Polyimide Film)

By using the non-thermoplastic polyimide film as a core film, an N,N-dimethylformamide solution of a polyamic acid which is a precursor of thermoplastic polyimide was coated onto both faces of the non-thermoplastic polyimide film by using a gravure coater. After coating, solvent drying and polyamic acid imidization were carried out by a heating treatment, and a laminate polyimide film consisting of a non-thermoplastic polyimide layer firm and a thermoplastic polyimide was prepared at a final heating temperature of 390° C. When 10-point average roughness of a surface of the thermoplastic polyimide layer, of the obtained laminate polyimide film, was measured by using a lightwave interfering type surface roughness meter, NewView 5030 system, available from ZYGO Co., Ltd., the measurement was 0.1 μm.

(Forming Metal Layer)

On one face of the laminated polyimide film, by using a sputtering device NSP-6 available from Showa Vacuum Co., Ltd., first, ion gun treatment was carried out for 20 minutes under a condition of argon gas atomosphere, beam voltage of 400 V, acceleration voltage of 500 V and beam current of 20 mA by means of filament cathode ion source (model name: 3-1500-100FC) and ion source power supply (MPS3000) available from Ion Tech Co., Ltd. Then, 6 nm of nickel (sputtering pressure of 0.2 Pa, DC output of 200 W, and sputtering time of 1 minute), 200 nm of copper (sputtering pressure of 0.2 Pa, DC output of 200 W, and sputtering time of 18 minutes) were continuously sputtered, and a laminate was prepared. Here, the sputtering device NSP-6 has the ion gun treatment device in a vacuum chamber, and is structured so that an ion gun treatment and a sputtering treatment can be continuously carried out. In addition, this device was subjected to an ion gun treatment or a sputtering treatment while 11 substrates were revolved and rotated on its axis in the chamber. That is, a time for each substrate to be subjected to the ion gun treatment or sputtering treatment is 5% to 7% of the total treating time. Then, a protective film having heat resistance and re-peeling property (Lioelm LE952-T1 available from Toyo Ink Manufacturing Co., Ltd.) was laminated on the metal layer.

(Forming Adhesive Layer)

The adhesive solution obtained in the same manner as embodiment 1 was coated on a face on which no metal layer of the laminate is formed, so that the thickness after dried becomes 12.5 μm, and then, an adhesive layer was formed by drying at 170° C. for 2 minutes. In this manner, a laminate consisting of a heat resistance protective film/a metal layer/a thermoplastic polyimide resin layer/a non-thermoplastic polyimide film/an adhesive layer was obtained.

(Laminating Step)

In the same manner as embodiment 1, lamination and curing was carried out on an inner layer circuit board, and a laminate consisting of a heat resistance protective film/a metal layer/a polyimide film layer/an adhesive layer/a copper foil-clad glass epoxy laminated board was obtained.

(Drilling, De-Smearing, and Chemical Copper Plating Step)

After peeling a heat resistance protective film on a surface of the laminate, the laminate was subjected to each of the steps under a condition shown in Table 6 in order to evaluate de-smearing liquid resistance property and electroless copper plating liquid resistance property of the laminate.

TABLE 6

| Order | | | |
|---|---|---|---|
| of steps | Prescription of treatment agents | | Condition |
| 1 | Swelling Securigant P(*) | 500 ml/l | 60° C., |
| | Sodium hydroxide | 3 g/l | 5 minutes |
| | (Wash by water) | | |
| 2 | Concentrate Compact CP(*) | 550 ml/l | 80° C., |
| | Sodium hydroxide | 40 g/l | 5 minutes |
| | (Wash by water) | | |
| 3 | Reduction Solution | 70 ml/l | 40° C., |
| | Securigant P500(*) | | 5 minutes |
| | Sulfuric acid | 50 ml/l | |
| | (Wash by water) | | |
| 4 | Cleaner Securigant 902(*) | 40 ml/l | 60° C., |
| | Cleaner additive 902(*) | 3 ml/l | 5 minutes |
| | Sodium hydroxide | 20 g/l | |
| | (Wash by water) | | |
| 5 | Pre-dip Neogant B(*) | 20 ml/l | Room |
| | Sulfuric acid | 1 ml/l | temperature |
| | | | and 1 minute |
| 6 | Activator Neogant 834 conc.(*) | 40 ml/l | 40° C., |
| | Sodium hydroxide | 4 g/l | 5 minutes |
| | Boric acid | 5 g/l | |
| | (Wash by water) | | |
| 7 | Reducer Neogant(*) | 1 g/l | Room |
| | Sodium hydroxide | 5 g/l | temperature |
| | | | and 2 minutes |
| | (Wash by water) | | |
| 8 | Basic Solution Printgant MSK-DK(*) | 80 ml/l | 35° C., |
| | Copper Solution Printgant MSK(*) | 40 ml/l | 15 minutes |
| | Stabilizer Printgant MSK-DK(*) | 3 ml/l | |
| | Reducer copper(*) | 14 ml/l | |
| | (Wash by water) | | |

(*)Available from Atotech Japan Co., Ltd.

(Electrplating of Copper Step

By using a copper sulfate plating bath (high throwing bath), electroplating was carried out at a current density of 2 A/dm² for 40 minutes, and the thickness of copper was 18 μm. As additive agents of the plating bath, Top Lutina Makeup (10 ml/l) and Top Lutina 81-HL (2.5 ml/l) were used.

In addition, measurement of an adhesion strength in a normal condition and a pressure cooker test were carried out in the same manner as that in mode 1.

(Forming Microcircuit)

By using a laminate consisting of a metal layer/a thermoplastic polyimide layer/a non-thermoplastic polyimide film/an adhesive layer/a glass epoxy copper sustained laminate board, a circuit having a line/space of 15 μm/15 μm was formed in accordance with a semi-additive process. A good circuit was successfully formed while an interface between a metal layer and a thermoplastic polyimide layer was smooth (Rz=0.1 μm) without generation of etching remnant.

### COMPARATIVE EXAMPLE 2

When a laminate was prepared in the same manner as that shown in Example 38 except that a thermoplastic polyimide layer was not formed on a non-thermoplastic polyimide film, a metal layer was cracked and released in the step of de-smearing, and a laminate was not successfully prepared.

### COMPARATIVE EXAMPLE 3

A metal layer was formed by processing steps 4 to 8 shown in Table 6 on a surface of an epoxy resin substrate which was surface-roughened at 3 μm in Rz. Using this metal layer, although a circuit having a line/space of 15 μm/15 μm was formed in accordance with a semi-additive technique, etching remnant were present on a resin surface, and a good circuit was not successfully formed.

### EXAMPLE 39

(Preparing Thermoplastic Polyimide Film)

A semi-cured film having self support property was obtained by coating the thermoplastic polyimide precursor obtained in Example 38 on a PET film having thickness of 125 μm by using a comma coater, and then, heating and drying at 120° C. for 4 minutes. This thermoplastic polyimide precursor film was peeled from the PET film; an end portion was fixed, heated, and imidized at a final heating temperature of 390° C.; and a thermoplastic polyimide film of a single layer having thickness of 25 μm was obtained.

(Laminating Metal Layer by Means of Sputtering)

On one face of the obtained thermoplastic polyimide film, nickel and copper were sputtered in the same manner as that shown in Example 38, and a laminate consisting of metal/thermoplastic polyimide was obtained.

(Laminating Step)

An inner layer circuit was prepared from a BT resin substrate having a copper foil of 12 μm. A face opposed to a face on which a metal layer of the laminate was opposed to the inner layer circuit. Then, lamination was carried out on the inner layer circuit by means of a vacuum press under a condition of a temperature of 260° C.; a hot-plate pressure of 3 MPa; a press time of 10 minutes; and a vacuum condition of 1 KPa.

In the same manner as in Example 1, the adhesion strengths in a normal condition and after a pressure cooker test were evaluated.

Table 7 shows a measurement result of the adhesion strengths of Examples 38 and 39 and Comparative Example 2.

TABLE 7

| | | | Adhesion | |
|---|---|---|---|---|
| | | | strength | |
| | | | (N/cm) | |
| | | Sputter | Normal | After |
| | Construction of laminate | pretreatmenting | condition | PCT |
| Ex. | Metal layer/thermoplastic | Ion gun | 13 | 5 |
| 38 | polyimide layer/non- | | | |
| | thermoplastic polyimide film | | | |
| Ex. | Metal layer/thermoplastic | Ion gun | 14 | 6 |
| 39 | polyimide layer | | | |

| | | | |
|---|---|---|---|
| Com. | Metal layer/non- | Ion gun | Measurement |
| Ex. 2 | thermoplastic polyimide film | | cannot be carried |
| | | | out because metal |
| | | | layer is released. |

### Embodiment 3 (Heating Treatment)

### EXAMPLE 40

By using a non-thermoplastic polyimide film and a thermoplastic polyimide precursor obtained in the same preparing method as in embodiment 2, a laminate polyimide film was prepared in the same manner as in embodiment 2.

(Forming Metal Layer)

On one face of the laminate polyimide film, while heating was carried out at 270° C. by means of a infrared-ray lamp heater, by using a sputtering device NSP-6 available from Showa Vacuum Co., Ltd., a laminate was prepared by sputtering 6 nm of nickel (sputtering pressure: 0.2 Pa, DC output: 200 W, and sputtering time: 1 minute) and 200 nm of copper (sputtering pressure: 0.2 Pa, DC output: 200 W; and sputtering time: 18 minutes).

Here, the sputtering device NSP-6 has a infrared-ray lamp heater device in a vacuum chamber, and is structured so that heating and sputtering treatmentes can be carried out simultaneously in parallel. That is, in this device, 11 substrates is heated on a lamp heater and is subject to a sputtering treatment while they is revolved and rotated on its axis in chamber. A time for each substrate to be subjected to the sputtering treatment is 5% to 7% of the whole treating time. A lamp heater temperature was measured and controlled by installing an electro-thermal couple in the middle of the lamp heater and the substrate. Further, a protective film (Lioelm LE952-T1 available from Toyo Ink Preparing Co., Ltd.) having heat resistance and re-peeling property was laminated on a metal layer.

(Preparing Adhesive Layer)

The adhesive solution obtained in the same manner as in embodiment 1 was coated on a face on which no metal layer of the laminate was formed so that the thickness after dried is 12.5 μm. Then, an adhesive layer was formed by drying at 170° C. for 2 minutes, and a laminate consisting of a heat resistance protective film/a metal layer/a thermoplastic polyimide resin layer/a non-thermoplastic polyimide film/an adhesive layer was obtained.

(Laminating Step)

In the same manner as in embodiments, lamination and curing was carried out on an inner layer circuit board, and a laminate consisting of a heat resistance protective film/a metal layer/a polyimide film layer/an adhesive layer/a copper foil-clad glass epoxy laminated board was obtained.

(Drilling, De-Smearing, and Chemical Copper Plating Step)

After peeling a heat resistance protective film on a surface of a laminate, a laminate was subjected to each of the steps under a condition shown in Table 6 in order to evaluate de-smearing liquid resistance property and electroless copper plating liquid resistance property of the laminate.

(Electroplating of Copper Step)

Electroplating of copper was carried out in the same manner as in embodiment 2.

In addition, measurement of an adhesion strength in a normal condition and a pressure cooker test were carried out in the same manner as in embodiment 1.

(Forming Microcircuit)

By using a laminate consisting of a metal layer/a thermoplastic polyimide layer/a non-thermoplastic polyimide film/an adhesive layer/a copper foil-clad glass epoxy laminated board, a circuit having a line/space of 15 μm/15 μm was formed in accordance with a semi-additive process. A good circuit was successfully formed while an interface between a metal layer and a thermoplastic polyimide layer was smooth (Rz=0.1 μm) without generation of etching remnant.

### EXAMPLE 41

Except that a heating temperature of a lamp heater was 150° C., a laminate was prepared in the same manner as in Example 40, and the adhesion strengths in a normal condition and pressure cooker were measured. By using the obtained laminate consisting of a metal layer/a thermoplastic polyimide layer/a non-thermoplastic polyimide film/a adhesive layer/a copper foil-clad glass epoxy laminated board, a circuit having a line/space of 15 μm/15 μm was formed in accordance with a semi-additive process. A good circuit was successfully formed while the interface between the metal layer and thermoplastic polyimide layer was smooth (Rz=0.1 μm) without generation of an etching remnant.

### COMPARATIVE EXAMPLE 4

Except that a thermoplastic polyimide layer was not formed on a non-thermoplastic polyimide film, a laminate was prepared in the same manner as in Example 40. The metal layer was cracked and released in the step of de-smearing, and a laminate was successfully prepared.

### COMPARATIVE EXAMPLE 5

A metal layer was formed on a surface of an epoxy resin substrate which was surface-roughened at 3 μm in Rz by processing the treatment steps 4 to 8 shown in Table 6 for. Using this, although a circuit having a line/space of 15 μm/15 μm was formed in accordance with a semi-additive process, an etching remnant were present on the resin surface, and a good circuit was not successfully formed.

Table 8 shows the results of Examples 40 and 41 and Comparative Example 4.

TABLE 8

| | | | Adhesion | |
|---|---|---|---|---|
| | | | strength | |
| | | | (N/cm) | |
| | | Heating | Normal | After |
| | Construction of laminate | temperature | condition | PCT |
| Ex. 40 | Metal layer/thermoplastic | 270° C. | 15 | 9 |
| | polyimide layer/non- | | | |
| | thermoplastic polyimide film | | | |
| Ex. 41 | Metal layer/thermoplastic | 150° C. | 13 | 8 |
| | polyimide layer/non- | | | |
| | thermoplastic polyimide film | | | |

| | | | |
|---|---|---|---|
| Com. | Metal layer/non- | 270° C. | Measurement |
| Ex. 4 | thermoplastic polyimide film | | cannot be carried |
| | | | out because metal |
| | | | layer is released. |

### Embodiment 4 (Surface Treatment)

### EXAMPLE 42

By using the non-thermoplastic polyimide film and thermoplastic polyimide precursor obtained in the same preparing method as in embodiment 2, a laminated polyimide film was prepared in the same manner as in embodiment 2.

(Surface Treatment of Thermoplastic Polyimide Resin Layer)

On one face of the obtained laminated polyimide film, while a gas composition was argon/helium/nitrogen; a partial pressure ratio was 8/2/0.2; and a pressure was 13300 Pa; and treating density was 1000 [W·minute/m²], plasma treatment was carried out.

(Forming Metal Layer)

On one face of the surface treated thermoplastic polyimide resin, de-smearing and electroless copper plating were carried out in the method shown in Table 6, and an electrolessly plated copper film (thickness: 0.3 μm) was formed on a surface of the thermoplastic polyimide resin. Then, by using a copper sulfate plating bath (high throwing bath), electoplating was carried out at a current density of 2 A/dm² for 40 minutes, and the thickness of copper was 18 μm. As an additive of the plating bath, Top Lutina Makeup (10 nm/l) and Top Lutina 81-HL (2.5 ml/l) available from Okuno Pharmaceuticals Co., Ltd. were used.

In addition, measurement of an adhesion strength in a normal condition and a pressure cooker test were carried out in the same manner as in embodiment 1.

(Forming Microcircuit)

After electroless copper plating on a surface-treated laminate consisting of a a thermoplastic polyimide resin/a non-thermoplastic polyimide film, a circuit having a line/space of 15 μm/15 μm was formed in accordance with a semi-additive process. A good circuit was successfully formed while an interface between a metal layer and a thermoplastic polyimide layer was smooth (Rz=0.1 μm) without generation of etching remnant.

### EXAMPLE 43

Except that a plasma treatment was substituted by a corona treatment having a treating density of 1000 (W·minute/m²], a laminate was prepared in the same manner as that shown in Example 42, and the adhesion strengths in a normal condition and after pressure cooker were measured. In addition, by using the obtained laminate consisting of the thermoplastic polyimide later/non-thermoplastic polyimide film, a circuit having a line/space of 15 μm/15 μm was formed in accordance with a semi-additive process. A good circuit was successfully formed while the interface between a metal layer and the thermoplastic polyimide layer was smooth (Rz=0.1 μm) without generation of the etching remnant.

### EXAMPLE 44

Except that a plasma treatment was substituted by a coupling agent treatment using a methanol solution of 0.1% by weight of γ-aminopropyltriethoxy silane (silane coupling agent KBE903: available from Shinetsu Chemical Engineering Co., Ltd.) as a coupling agent solution, a laminate was prepared in the same manner as that shown in Example 42, and the adhesion strengths in a normal condition and after a pressure cooker were measured. In addition, by using the obtained laminate consisting of the thermoplastic polyimide later/non-thermoplastic polyimide film, a circuit having a line/space of 15 μm/15 μm was formed in accordance with a semi-additive process. A good circuit was successfully formed while the interface between a metal layer and a thermoplastic polyimide layer was smooth (Rz=0.1 μm) without generation of the etching remnant.

### EXAMPLE 45

Except that a plasma treatment was substituted by immersing at 80° C. for 5 minutes in a sodium permanganate water solution having dissolved 550 ml of a Concentrate Compact CP available from Atotexh Japan Co., Ltd. and 40 g of sodium hydroxide and adjusted volume to 1 litter by water, a laminate was prepared in the same manner as in Example 42, and the adhesion strengths in a normal condition and after a pressure cooker were measured. In addition, by using the obtained laminate consisting of the thermoplastic polyimide layer/non-thermoplastic polyimide film, a circuit having a line/space of 15 μm/15 μm was formed in accordance with a semi-additive process. A good circuit was successfully formed while the interface between a metal layer and a thermoplastic polyimide layer was smooth (Rz=0.1 μm) without generation of the etching remnant.

### EXAMPLE 46

Except that a plasma treatment was substituted by a ultraviolet-ray emitting treatment at a luminescence of 20 mW/cm² and an emission time of 5 minutes, a laminate was prepared in the same manner as that shown in Example 42, and the adhesion strengths in a normal condition and after a pressure cooker were measured. In addition, by using the obtained laminate consisting of the thermoplastic polyimide later/non-thermoplastic polyimide film, a circuit having a line/space of 15 μm/15 μm was formed in accordance with a semi-additive process. A good circuit was successfully formed while the interface between a metal layer and a thermoplastic polyimide layer was smooth (Rz=0.1 μm) without generation of the etching remnant.

### EXAMPLE 47

Except that a plasma treatment was substituted by an electron beam emitting treatment having an emission dose of 500 kGy, a laminate was prepared in the same manner as that shown in Example 42, and the adhesion strengths in a normal condition and after a pressure cooker were measured. In addition, by using the obtained laminate consisting of the thermoplastic polyimide layer/non-thermoplastic polyimide film, a circuit having a line/space of 15 μm/15 μm was formed in accordance with a semi-additive process. A good circuit was successfully formed while the interface between a metal layer and a thermoplastic polyimide layer was smooth (Rz=0.1 μm) without generation of the etching remnant.

### EXAMPLE 48

Except that a plasma treatment was substituted by a sand blast treatment in which silica sand of 0.1 mm to 1 mm in particle size is used; an angle and an interval between a blowout nozzle and a polyimide film are 45 degree and 100 m; and the blowout quantity is 6 kg per minute, a laminate was prepared in the same manner as in Example 42, and the adhesion strengths in a normal condition and after a pressure cooker were measured. In addition, by using the obtained laminate consisting of the thermoplastic polyimide layer/non-thermoplastic polyimide film, a circuit having a line/space of 15 μm/15 μm was formed in accordance with a semi-additive process. A good circuit was successfully formed while the interface between a metal layer and a thermoplastic polyimide layer was smooth (Rz=0.1 μl) without generation of the etching remnant.

### EXAMPLE 49

Except that a plasma treatment was substituted by a firing treatment in which a fire of 1600° C. is used; a cooling roll temperature is 50° C.; and a film runs at a portion which is ⅓ of a fire length from a distal end of the fire, a laminate was prepared in the same manner as in Example 42, and the adhesion strengths in a normal condition and after a pressure cooker were measured. In addition, by using the obtained laminate consisting of the thermoplastic polyimide layer/non-thermoplastic polyimide film, a circuit having a line/space of 15 μm/15 μm was formed in accordance with a semi-additive process. A good circuit was successfully formed while the interface between a metal layer and a thermoplastic polyimide layer was smooth (Rz=0.1 μm) without generation of the etching remnant.

### EXAMPLE 50

Except that a plasma treatment was substituted by a hydrophilization treatment for carrying out immersion at 30° C. for 2 minutes in a water solution which included hydrazine hydrate and sodium hydroxide at a rate of 5 mol/L and 1 mol/L, a laminate was prepared in the same manner as in Example 42, and the adhesion strengths in a normal condition and after a pressure cooker were measured. In addition, by using the obtained laminate consisting of thermoplastic polyimide layer/non-thermoplastic polyimide film, a circuit having a line/space of 15 μm/15 μm was formed in accordance with a semi-additive process. A good circuit was successfully formed while the interface between a metal layer and a thermoplastic polyimide layer was smooth (Rz=0.1 μm) without generation of the etching remnant.

### COMPARATIVE EXAMPLE 6

Except that a thermoplastic polyimide resin layer is not formed on the non-thermoplastic polyimide film obtained by the method described in Example 42, a laminate was prepared in the same manner as in Example 42, and the adhesion strengths in a normal condition and after pressure cooker test were measured. In addition, by using the obtained laminate consisting of a thermoplastic polyimide layer/a non-thermoplastic polyimide film, a circuit having a line/space of 15 μm/15 μm was formed in accordance with a semi-additive process. The adhesion of an interface between a metal layer and a thermoplastic polyimide layer was weak, and a pattern was released, and a printed circuit board was not successfully prepared.

### COMPARATIVE EXAMPLE 7

Except that a plasma treatment was substituted by an electron beam emitting treatment having an emission dose of 500 kGy, a laminate was prepared in the same manner as that shown in Comparative Example 6, and the adhesion strengths in a normal condition and after pressure cooker test was measured. In addition, by using the obtained laminate consisting of a thermoplastic polyimide layer/a non-thermoplastic polyimide film, a circuit having a line/space of 15 μm/15 μm was formed in accordance with a semi-additive process. The adhesion of an interface between a metal layer and a thermoplastic polyimide layer was weak, and a pattern was released, and a printed circuit board was not successfully prepared.

### COMPARATIVE EXAMPLE 8

Except that a plasma treatment was substituted by immersing at 80° C. for 5 minutes in a sodium permanganate water solution having dissolved 550 ml of a Concentrate Compact CP available from Atotexh Japan Co., Ltd. and 40 g of sodium hydroxide and adjusted volume to 1 litter by water, a laminate was prepared in the same manner as in Comparative Example 6, and the adhesion strengths in a normal condition and after pressure cooker test was measured. In addition, by using the obtained laminate consisting of a thermoplastic polyimide layer/a non-thermoplastic polyimide film, a circuit having a line/space of 15 μm/15 μm was formed in accordance with a semi-additive process. The adhesion of an interface between a metal layer and a thermoplastic polyimide layer was weak, and a pattern was released, and a printed circuit board was not successfully prepared.

### COMPARATIVE EXAMPLE 9

A metal layer was formed on a surface of an epoxy resin board surface-roughened at 3 μm in Rz by carrying out the treatment steps 4 to 8 shown in Table 6. By using this, although a circuit having a line/space of 15 μm/15 μm was formed, an etching remnant was present on the resin surface, and a good circuit was not successfully formed.

Table 9 shows a measurement result of the adhesion strengths in Examples 42 to 50 and Comparative Examples 6 to 8.

TABLE 9

| | | | adhesion force of | |
|---|---|---|---|---|
| | | | electrolessly plating | |
| | | | of copper (N/cm) | |
| | | | (Normal | |
| | Polyimide resin | Surface treatment | condition) | (After PCT) |
| Ex. 42 | Thermoplastic | Plasma | 7 | 4 |
| Ex. 43 | polyimide/non- | Corona | 8 | 5 |
| Ex. 44 | thermoplastic | Coupling agent | 7 | 4 |
| Ex. 45 | polyimide | Permanganate | 7 | 4 |
| Ex. 46 | | Ultraviolet-ray | 8 | 5 |
| | | emission | | |
| Ex. 47 | | Electron beam | 7 | 4 |
| | | emission | | |
| Ex. 48 | | Sand blast | 7 | 4 |
| Ex. 49 | | Firing | 6 | 3 |
| Ex. 50 | | Hydrophilization | 7 | 4 |
| Com. | Non- | Plasma | 1 | 0.1 |
| Ex. 6 | thermoplastic | | | |
| Com. | polyimide | Electron beam | 2 | 0.2 |
| Ex. 7 | | | | |
| Com. | | Permanganate | 1 | 0.1 |
| Ex. 8 | | | | |

### Embodiment 5 (Panel Plating After Laminating with Inner Layer Circuit Board)

(Preparing Laminate)

There were used: the non-thermoplastic polyimide film prepared in accordance with preparing methods A, B, and C described in embodiment 1; the thermoplastic polyimide precursor prepared in accordance with thermoplastic polyimide precursor preparing methods X and Y; and an adhesive solution.

By using the non-thermoplastic polyimide film prepared in accordance with preparing methods A, B, and C as a core film, respectively, a DMF solution of a polyamic acid which is a precursor of the thermoplastic polyimide prepared in accordance with preparing methods X and Y was coated on one face of the film by using a gravure coater.

After coating, solvent drying and polyamic acid imidization were carried out by means of a heating treatment, and a laminated polyimide film consisting of a non-thermoplastic polyimide layer and a thermoplastic polyimide layer was prepared at a final heating temperature of 390° C. While changing a coating quantity, a film having different thickness of a thermoplastic polyimide layer was obtained.

The adhesive solution was coated on the non-thermoplastic polyimide film so that the thickness after dried is 12.5 μm. Then, an adhesive layer was formed by drying at 170° C. for 2 minutes, and an laminate was obtained. In the table, the obtained laminate was described as an X/A/adhesive layer in the case where, the non-thermoplastic polyimide film was prepared in accordance with method A and the thermoplastic polyimide layer was prepared on one face of the film in accordance with method X.

(Laminating Step)

An inner layered circuit board was prepared from a copper foil-clad glass epoxy laminated board having a copper foil of 12 μm. By means of a vacuum press, the laminate was laminated and cured on the inner layered circuit board at a temperature of 200° C., at a hot-plate pressure of 3 MPa, at a press time of 2 hours, and under a vacuum condition of 1 KPa.

(Panel Plating in Accordance with Sputtering Method)

By using a sputtering device NSP-6 available from Showa Vacuum Co., Ltd., a panel plating layer was formed on a thermoplastic polyimide resin layer after laminated in accordance with the following method.

A substrate laminated with an inner layer circuit board and a laminate was set to a jig, and a vacuum chamber was closed. While the substrate was revolved and rotated on its axis, heating was carried out by means of a lamp heater, and vacuum drawing was carried out up to 6×10⁻⁴ Pa or less. Then, argon gas was introduced, and was set at 0.35 Pa. Then, nickel and copper was sputtered by means of DC sputtering, respectively. DC powers were 200 W both. A filming speed was 7 nm per minute in nickel and 11 nm per minute in copper, and the film thickness was controlled by adjusting a filming time.

In addition, measurement of an adhesion strength in a normal condition and a pressure cooker test were carried out in the same manner as that shown in embodiment 1. Upon measurement, a copper layer having thickness of 18 μm was formed by electroplating on a copper layer formed by sputtering.

### EXAMPLES 51 TO 56

A laminate was obtained by using a polyamic acid solution prepared in accordance with preparing method X or Y for one face of the non-thermoplastic polyimide film having thickness of 25 μm prepared in accordance with preparing method A, B, or C; and using an adhesive solution for the other face of the film. The thickness of the thermoplastic polyimide layer was 3 μm. The laminate was laminated on a circuit-formed glass epoxy substrate. Then, a via hole having a inside diameter of 30 μm which reaches an inner layer circuit was formed by means of a UV-YAG laser. Then, de-smearing was carried out by using an oxygen plasma. Next, on the thermoplastic polyimide layer, a nickel film having thickness of 10 nm was formed by means of nickel sputtering, and continuously, a copper layer having thickness of 250 nm was formed by means of copper sputtering. On the obtained sputtered film, a copper layer having thickness of 18 μm was formed in accordance with an electroplating method. The adhesion strength at a room temperature of this laminate; the adhesion strength after pressure cooker test; and an effect of a de-smearing treatment were evaluated. The evaluation result is shown in Table 10.

TABLE 10

| | | | | Adhesion | |
|---|---|---|---|---|---|
| | Polyimide | | | strength | Effect of de- |
| | preparing | | Peel | after PCT | smearing by |
| | method and | Construction | strength | test | oxygen |
| Ex. | construction | of metal layer | (N/cm) | (N/cm) | plasma |
| 51 | X/A/adhesive | Ni/Cu | 14 | 8 | Good |
| | layer | | | | |
| 52 | X/B/adhesive | Same as | 12 | 9 | Good |
| | layer | above | | | |
| 53 | X/C/adhesive | Same as | 11 | 9 | Good |
| | layer | above | | | |
| 54 | Y/A/adhesive | Same as | 14 | 9 | Good |
| | layer | above | | | |
| 55 | Y/B/adhesive | Same as | 13 | 7 | Good |
| | layer | above | | | |
| 56 | Y/C/adhesive | Same as | 12 | 8 | Good |
| | layer | above | | | |

From this result, it was found that the laminate according to the present invention can achieve excellent adhesion property. In addition, de-smearing was well carried out, and a conductive layer was well formed inside of the via hole.

### COMPARATIVE EXAMPLE 10

By using a non-thermoplastic polyimide film A (i.e., film free of thermoplastic polyimide layer), except that a thermoplastic polyimide film is not formed on a surface of the film, a sample was prepared in the same manner as in Example 51, and the adhesion property and an effect of a de-smearing treatment were evaluated in the same manner. As a result, although the adhesion strength was 7N/cm, the adhesion strength after pressure cooker test was lowered to 2N/cm. In addition, de-smearing was well carried out. By comparing this result with that shown in Table 10, it was found that predetermined characteristics was not obtained in the case where no thermoplastic polyimide layer is present, and the effect of the thermoplastic polyimide layer was successfully verified.

### EXAMPLES 57 TO 71

Except that a metal layer having formed thereon a nickel undercoat layer and a copper layer with various thickness or a nickel single layer was formed, an procedure was made in the same manner as in Example 51, and the adhesion property and the effect of the de-smearing treatment were evaluated in the same manner. The evaluation result is shown in Table 11. C was used as a non-thermoplastic polyimide film and Y was used as a thermoplastic polyimide.

TABLE 11

| | Thickness of | Thickness of | | Adhesion | |
|---|---|---|---|---|---|
| | nickel | copper layer | | strength | Effect of de- |
| | undercoat | (second | Adhesion | after PCT | smearing due |
| | layer | metal layer) | strength | test | to oxygen |
| Ex. | (nm) | (nm) | (N/cm) | (N/cm) | plasma |
| 57 | 2 | 250 | 11 | 5 | Good |
| 58 | 5 | 250 | 11 | 8 | Good |
| 59 | 10 | 50 | 10 | 5 | Good |
| 60 | 10 | 100 | 12 | 5 | Good |
| 61 | 10 | 250 | 12 | 8 | Good |
| 62 | 10 | 500 | 12 | 8 | Good |
| 63 | 10 | 1000 | 12 | 9 | Good |
| 64 | 10 | 2500 | 12 | 8 | Good |
| 65 | 20 | 250 | 14 | 8 | Good |
| 66 | 50 | 250 | 10 | 7 | Good |
| 67 | 250 | 0 | 10 | 6 | Good |
| 68 | 500 | 0 | 10 | 6 | Good |
| 69 | 1000 | 0 | 9 | 5 | Good |
| 70 | 1500 | 0 | 9 | 4 | Good |
| 71 | 3000 | 0 | 8 | 4 | Good |

From this result, adhesion property was good. In addition, de-smearing was well carried out, and a conductive layer was well formed inside of a via hole.

### EXAMPLE 72

A laminate was obtained by using the polyamic acid solution prepared in accordance with fabrication technique Y for one face of the non-thermoplastic polyimide film having thickness of 25 μm prepared in accordance with preparing method C and using an adhesive solution for the other face of the film. The thickness of the thermoplastic polyimide layer was 3 μm. The laminate was laminated on a circuit formed glass epoxy substrate. Then, a via hole having a inside diameter of 30 μm which reaches an inner layer circuit was formed by means of a UV-YAG laser. Then, de-smearing was carried out by using oxygen plasma. Next, on the thermoplastic polyimide layer, nickel film having thickness of 6 nm was formed by means of nickel sputtering, and continuously a copper film having thickness of 100 nm was formed by means of copper sputtering. After coating a liquid photosensitive plating resist (THB320P available from Nippon Synthesis Rubber Co., Ltd.), mask exposure was carried out by using a high voltage mercury lamp, and a resist pattern having a line/space of 10 μm/10 μm was formed. Subsequently, electroplating of copper was carried out, and a copper circuit was formed on a surface of a portion at which an electrolessly plated copper film is exposed. Electroplating was carried out by preliminary washing for 30 second in 10% sulfuric acid, and then, plating for 40 minutes in room temperature. The current density was 2A/dm². The thickness of an electrolytic copper film was 10 μm. Next, a plating resist was peeled by using an alkali type release liquid; a sputtered nickel layer was removed by selective etching liquid of nickel (etching liquid, NH-1862 available from Meck Co., Ltd.); and a printed circuit board was obtained.

The obtained printed circuit board has a line/space as specified at a designed value, and no undercut was observed. Further, although Auger electron spectroscopy of a peeled portion of feeding layer and measurement of the presence or absence of the residual metal by EPMA were carried out, the presence of the residual metal was not observed. In addition, a circuit pattern was strongly adhered by a strength of 13 N/cm. De-smearing was well carried out, and a conductor layer was well formed inside of a via hole.

### INDUSTRIAL APPLICABILITY

A printed circuit board fprepared by using a laminate according to the present invention, the laminate having a thermoplastic polyimide layer and a metal layer, or alternatively, a thermoplastic polyimide layer, a non-thermoplastic polyimide layer, and a metal layer, is capable of high density wiring, is excellent in adhesion stability, has excellent adhesion reliability for a pressure cooker resistance test, and further, has a process resistance property such as a de-smearing resistance or the like.

In addition, when the laminate according to the present invention is prepared, a metal layer is formed while heating the thermoplastic polyimide layer surface, thereby making it possible to provide a laminate and a printed circuit board having de-smearing liquid resistance property and pressure cooker resistance of adhesion strength.

In addition, when the laminate according to the present invention is prepared, there can be provided a laminate and a printed circuit board having strongly adhesion property to a smooth thermoplastic polyimide resin surface and excellent adhesion stability under a high temperature and/or a high humidity environment, wherein the thermoplastic polyimide layer surface is surface-treated by carrying out surface treatment by combining one or more selected from an ion gun treatment, a plasma treatment, a corona treatment, a coupling agent treatment, a per manganese acid salt treatment, a ultraviolet ray emitting treatment, an electron beam emitting treatment, surface treatmenting by colliding an abrasive at a high speed, a firing treatment, and a hydrophilization treatment.

Moreover, when a printed circuit board is prepared, a metal layer is formed in accordance with a physical vapor deposition method instead of a conventional wet type electroless plating, thereby making it possible to reduce environmental contamination.

Therefore, the printed circuit board according to the present invention can be used as: a flexible printed circuit board having high density and excellent adhesion stability under a high temperature and/or a high humidity environment; a multi-layered printed circuit board laminated with the flexible printed circuit board; a rigid flex circuit board laminated with the flexible printed circuit board and a hard printed circuit board; a buildup circuit board; a TAB tape; a COF substrate having a semiconductor element directly mounted on the printed circuit board; and a printed circuit board for an electronic device such as an MCM substrate.

1. A laminate comprising a thermoplastic polyimide layer, and a metal layer on a surface of the thermoplastic polyimide layer.

2. The laminate of claim 1, wherein said thermoplastic polyimide layer is surface-treated by at least one treatment selected from the group consisting of a plasma treatment, a corona treatment, a coupling agent treatment, a permanganate treatment, a ultraviolet ray emitting treatment, an electron beam emitting treatment, surface treatment by colliding an abrasive at a high speed, a firing treatment, and a hydrophilization treatment.

3. The laminate of claim 1, wherein said thermoplastic polyimide layer is surface-treated by means of an ion gun treatment.

4. The laminate of claim 3, wherein said ion gun treatment is a treatment using argon ion.

5. The laminate of claim 1, wherein said metal layer is formed by depositing a metal element while heating the thermoplastic polyimide layer.

6. The laminate of claim 5, wherein a heating temperature is at least 100° C.

7. The laminate of any one of claims 1, 2, 3 or 4, wherein said metal layer is an electrolessly plated layer.

8. The laminate of claim 6, wherein said metal layer is formed by at least one method selected from the group consisting of a sputtering method, a vacuum vapor deposition method, an ion plating method, an electron beam vapor deposition method, and a chemical vapor deposition method.

9. The laminate of claim 8, wherein said metal layer comprises a first metal layer and a second metal layer.

10. The laminate of claim 9, wherein said first metal layer comprises nickel, cobalt, chrome, titanium, molybdenum, tungsten, zinc, tin, indium, gold, or an alloy thereof.

11. The laminate of claim 10, wherein said second metal layer comprises copper or an alloy thereof.

12. A laminate comprising
a non-thermoplastic polyimide layer having a thermoplastic polyimide layer on at least one face; and
a metal layer formed on at least one face of surfaces of said thermoplastic polyimide layer.

13. A laminate comprising
a thermoplastic polyimide layer and a metal layer formed on said thermoplastic polyimide layer on one surface, and an adhesive layer on the other face.

14. A laminate comprising
a thermoplastic polyimide layer and a metal layer formed on said thermoplastic polyimide layer on one surface, and a copper foil on the other face.

15. The laminate of any one of claims 12, 13, or 14, wherein said thermoplastic polyimide layer is surface-treated by at least one treatment selected from the group consisting of a plasma treatment, a corona treatment, a coupling agent treatment, a permanganate treatment, a ultraviolet ray emitting treatment, an electron beam emitting treatment, surface treatment by colliding an abrasive at a high speed, a firing treatment, and a hydrophilization treatment.

16. The laminate of any one of claims 12, 13, or 14, wherein said thermoplastic polyimide layer is surface-treated by an ion gun treatment.

17. The laminate of claim 16, wherein said ion gun treatment is a treatment using argon ion.

18. The laminate of claim 12, 13, or 14, wherein said metal layer is formed by depositing a metal element while heating the thermoplastic polyimide layer.

19. The laminate of claim 18, wherein a heating temperature is at least 100° C.

20. A laminate comprising a polyimide film and a metal layer, wherein said polyimide film is at least two-layered structure which comprises a non-thermoplastic polyimide layer and a thermoplastic polyimide layer formed on at least one face of the non-thermoplastic polyimide layer; and said metal layer comprises a first metal layer which comprises nickel, cobalt, chrome, titanium, molybdenum, tungsten, zinc, tin, indium, gold, or an alloy thereof, and a second metal layer which comprises copper or an alloy thereof on the first metal layer.

21. The laminate of any one of claims 1, 12, 13, 14, or 20, wherein said thermoplastic polyimide layer comprises a thermoplastic polyimide which is obtained by dehydration and ring-closing a polyamic acid represented by the following general formula (1); 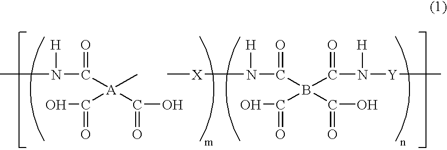
wherein A is a quadrivalent organic group selected from the following formula (2), and may be the same or different; X is a divalent organic group selected from the following formula (3), and may be the same or different; B is a quadrivalent organic group other than those represented by the formula (2), and may the same or different; Y is a divalent organic group other than those represented by the formula (3), and may be the same or different. m:n is 100:0 to 50:50.)

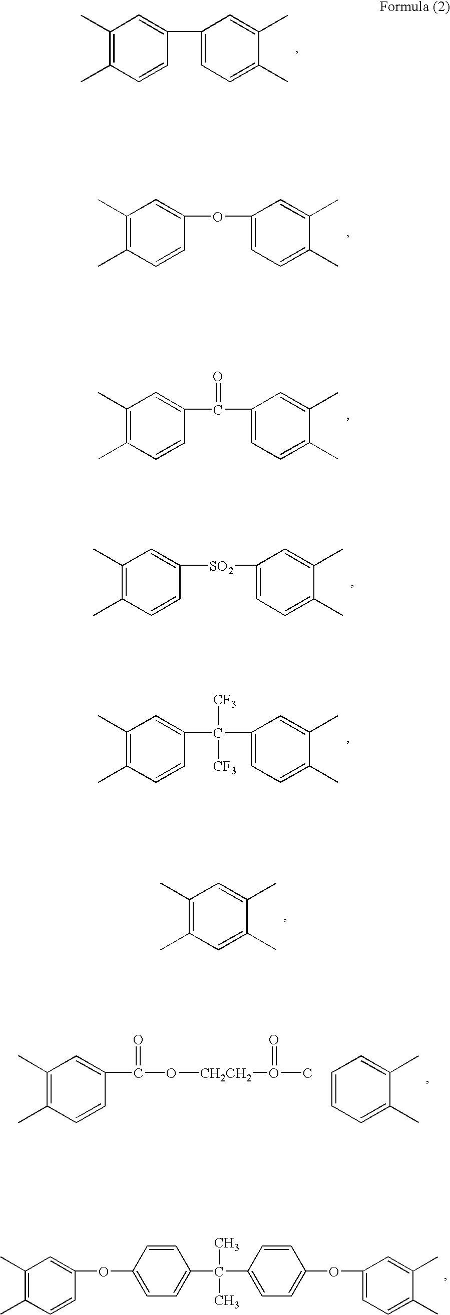

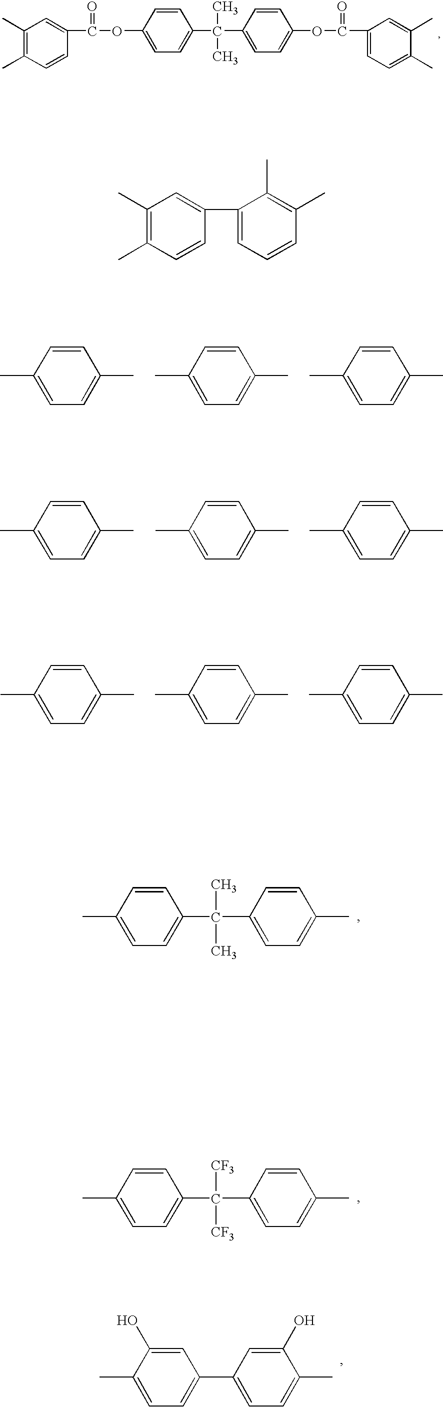

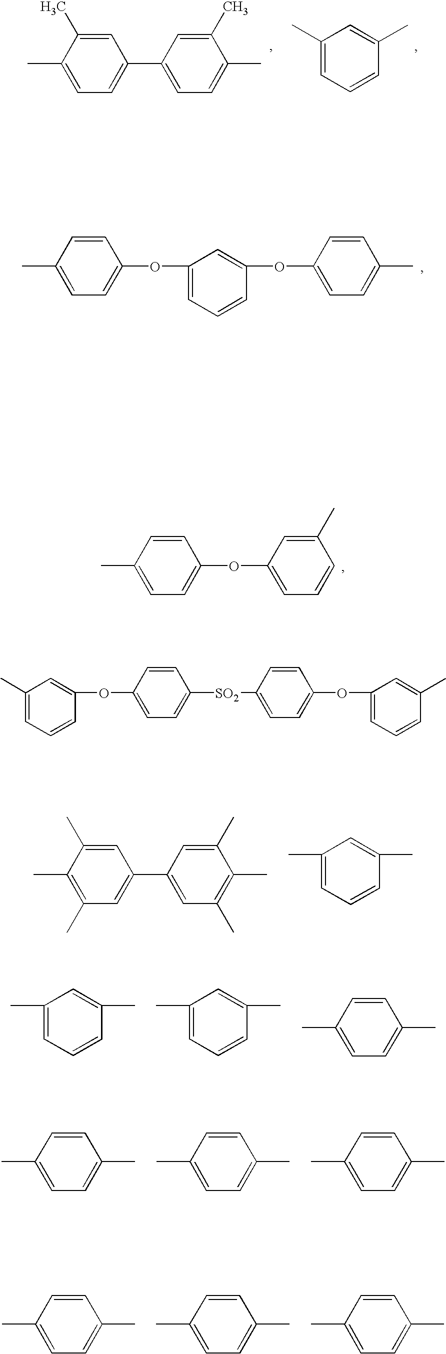

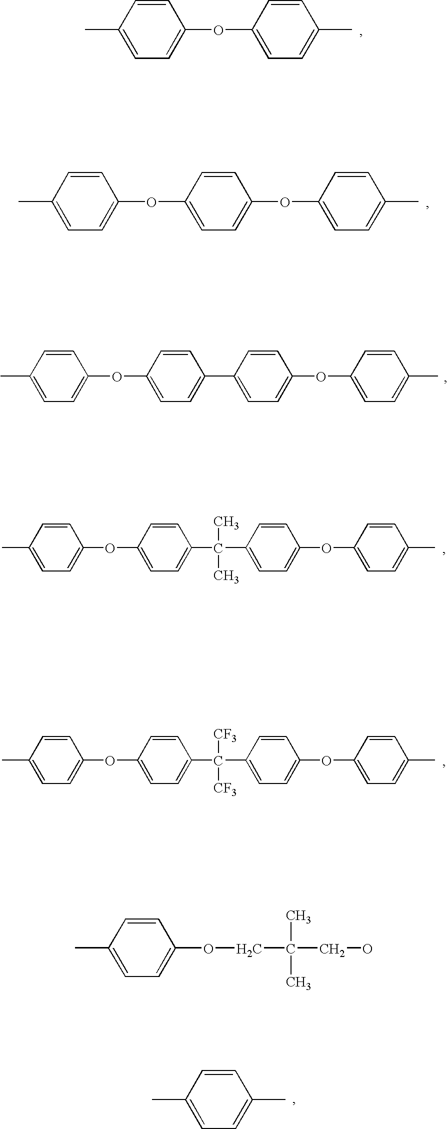

22. The laminate of any one of claims 12, 13, 14, or 20, wherein thickness of said thermoplastic polyimide layer is at least 0.01 μm to at most 10 μm, and is thicker than the non-thermoplastic polyimide layer.

23. A thermoplastic polyimide film which is obtained by surface-treated by at least one treatment selected from the group consisting of a plasma treatment, a corona treatment, a coupling agent treatment, a permanganate treatment, a ultraviolet ray emitting treatment, an electron beam emitting treatment, surface treatment by colliding an abrasive at a high speed, a firing treatment, and a hydrophilization treatment.

24. A method for preparing a printed circuit board, which comprises the steps of:
forming a thermoplastic polyimide resin layer on one face of a non-thermoplastic polyimide film,
forming an adhesive layer on the other face of the non-thermoplastic polyimide film,
opposing the adhesive layer and a circuit face of a circuit-formed circuit board to each other to laminate in accordance with a method using heating and/or pressurization, and
carrying out panel plating in accordance with a physical vapor deposition method on a thermoplastic polyimide layer surface after laminating.

25. A method for preparing a printed circuit board which comprises the steps of,
laminating the other face of the non-thermoplastic polyimide film on a circuit-formed circuit board via an adhesive sheet in accordance with a method using heating and/or pressurization; and
carrying out panel plating in accordance with a physical vapor deposition method on a thermoplastic polyimide layer surface after laminating.
